(19) United States
(12) Patent Application Publication
(10) Pub. No.: US 2020/0210181 A1
(43) Pub. Date: Jul. 2, 2020

(54) APPARATUSES, METHODS, AND SYSTEMS FOR VECTOR ELEMENT SORTING INSTRUCTIONS

(71) Applicant: Intel Corporation, Santa Clara, CA (US)

(72) Inventor: ElMoustapha Ould-Ahmed-Vall, Chandler, AZ (US)

(21) Appl. No.: 16/236,445

(22) Filed: Dec. 29, 2018

(51) Int. Cl. G06F 9/30

(52) U.S. Cl. CPC G06F 9/3016; G06F 9/30123; G06F 9/30036

(57) ABSTRACT

Systems, methods, and apparatuses relating to performing a sort operation on a packed data source to generate a packed data resultant are described. In one embodiment, a processor includes a decoder to decode a single instruction into a decoded single instruction, the single instruction having at least one field that identifies a packed data source and a packed data destination, and an opcode that is to indicate a sort type; and an execution circuit to execute the decoded single instruction to: provide storage for a comparison matrix to store a comparison value for each element of the packed data source against the other elements of the packed data source, perform a same comparison operation on each element of the packed data source against the other elements of the packed data source to populate the comparison matrix, add each column of results in the comparison matrix to generate each element of a packed data count, move each element of the packed data source according to the packed data count to generate a packed data result that is sorted by the sort type indicated by the opcode, and store the packed data result into the packed data destination.

### TECHNICAL FIELD

The disclosure relates generally to electronics, and, more specifically, an embodiment of the disclosure relates to circuitry to implement a vector element sorting instruction.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a hardware processor coupled to a memory according to embodiments of the disclosure.

FIG. 2 illustrates a hardware processor coupled to storage that includes one or more packed data sorting instructions according to embodiments of the disclosure.

FIG. 3 illustrates a method of processing a packed data sorting instruction according to embodiments of the disclosure.

FIG. 4 illustrates circuitry including an execution circuit with comparison operation circuitry, count determiner circuitry, count sorter circuitry, and permutation circuitry according to embodiments of the disclosure.

FIG. 5 illustrates circuitry including an execution circuit with duplicate determiner circuitry, comparison operation circuitry, count determiner circuitry, count sorter circuitry, and permutation circuitry according to embodiments of the disclosure.

FIG. 6 illustrates circuitry including an execution circuit with comparison operation circuitry, count determiner circuitry, count sorter circuitry that sources an immediate value, and permutation circuitry according to embodiments of the disclosure.

FIG. 7 illustrates circuitry including an execution circuit with duplicate determiner circuitry, comparison operation circuitry, count determiner circuitry, count sorter circuitry, and permutation circuitry that sources an immediate value according to embodiments of the disclosure.

FIG. 8 illustrates circuitry including an execution circuit with duplicate determiner circuitry, comparison operation circuitry, count determiner circuitry, count sorter circuitry that sources a first immediate value, and permutation circuitry that sources a second immediate value according to embodiments of the disclosure.

FIG. 9 illustrates circuitry including an execution circuit with comparison operation circuitry, count determiner circuitry, count sorter circuitry, and permutation circuitry according to embodiments of the disclosure.

FIG. 10A is a block diagram illustrating a generic vector friendly instruction format and class A instruction templates thereof according to embodiments of the disclosure.

FIG. 10B is a block diagram illustrating the generic vector friendly instruction format and class B instruction templates thereof according to embodiments of the disclosure.

FIG. 11A is a block diagram illustrating fields for the generic vector friendly instruction formats in FIGS. 10A and 10B according to embodiments of the disclosure.

FIG. 11B is a block diagram illustrating the fields of the specific vector friendly instruction format in FIG. 11A that make up a full opcode field according to one embodiment of the disclosure.

FIG. 11C is a block diagram illustrating the fields of the specific vector friendly instruction format in FIG. 11A that make up a register index field according to one embodiment of the disclosure.

FIG. 11D is a block diagram illustrating the fields of the specific vector friendly instruction format in FIG. 11A that make up the augmentation operation field 1050 according to one embodiment of the disclosure.

FIG. 12 is a block diagram of a register architecture according to one embodiment of the disclosure.

FIG. 13A is a block diagram illustrating both an exemplary in-order pipeline and an exemplary register renaming, out-of-order issue/execution pipeline according to embodiments of the disclosure.

FIG. 13B is a block diagram illustrating both an exemplary embodiment of an in-order architecture core and an exemplary register renaming, out-of-order issue/execution architecture core to be included in a processor according to embodiments of the disclosure.

FIG. 14A is a block diagram of a single processor core, along with its connection to the on-die interconnect network and with its local subset of the Level 2 (L2) cache, according to embodiments of the disclosure.

FIG. 14B is an expanded view of part of the processor core in FIG. 14A according to embodiments of the disclosure.

FIG. 15 is a block diagram of a processor that may have more than one core, may have an integrated memory controller, and may have integrated graphics according to embodiments of the disclosure.

FIG. 16 is a block diagram of a system in accordance with one embodiment of the present disclosure.

FIG. 17 is a block diagram of a more specific exemplary system in accordance with an embodiment of the present disclosure.

FIG. 18, shown is a block diagram of a second more specific exemplary system in accordance with an embodiment of the present disclosure.

FIG. 19, shown is a block diagram of a system on a chip (SoC) in accordance with an embodiment of the present disclosure.

FIG. 20 is a block diagram contrasting the use of a software instruction converter to convert binary instructions in a source instruction set to binary instructions in a target instruction set according to embodiments of the disclosure.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

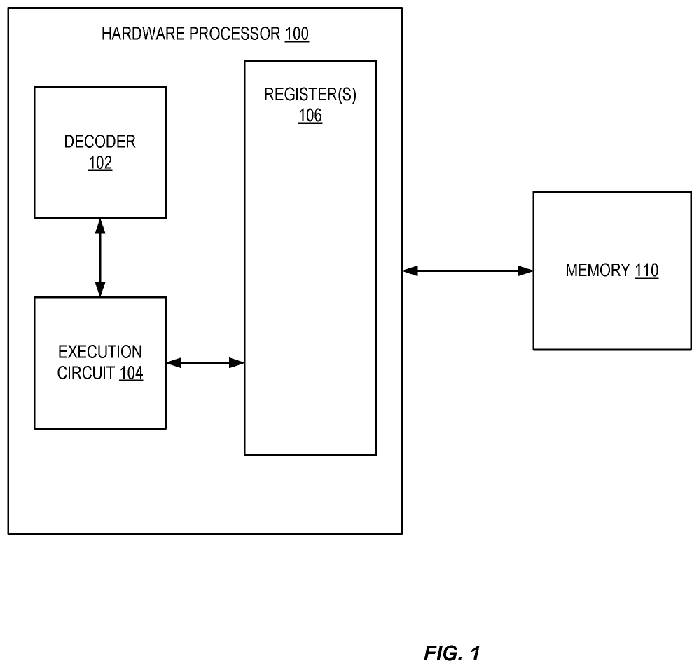

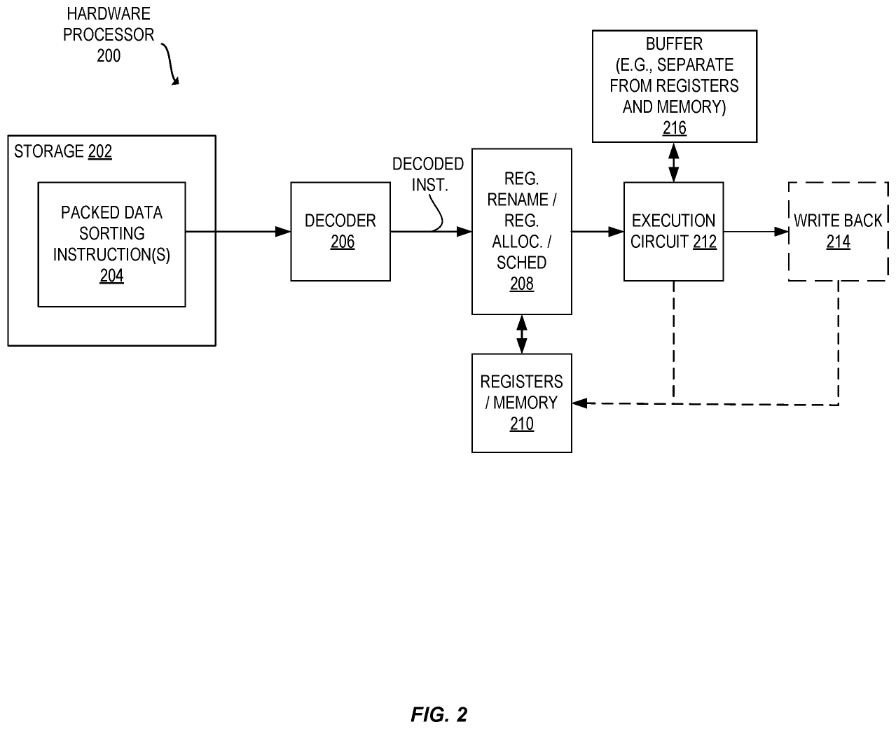

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. One non-limiting example of an operation is a packed data sorting operation to generate a sorted (e.g., sorted from numerically high to numerically low or from numerically low to numerically high) resultant of elements from a packed data source. In certain embodiments, a packed data sorting operation is accomplished with the decode and execution of a single instruction, for example, that does not use multiple decode, execution, and/or retirement cycles of an instruction execution pipeline and/or does not consume the extra time and energy that it would take to decode, execute, and/or retire a plurality of instructions. In one embodiment, a packed data sorting operation is accomplished with the decode and execution of a single instruction that does not use registers and/or memory to store values other than as an input storage location of the packed data source and as an output storage location of the packed data destination. In one embodiment, a processor (e.g., core) includes a buffer that is separate from the registers and memory (e.g., separate from memory 110 in FIG. 1 or separate from registers/memory 210 in FIG. 2). In certain embodiments, the packed data resultant is stored in a vector register.

An instruction format may include an opcode (e.g., a proper subset of the opcode) or field (e.g., operand or immediate) to indicate a sort type to be performed. An instruction format may include an opcode (e.g., a proper subset of the opcode) or field (e.g., operand or immediate) to indicate that the execution of a single, packed data sorting instruction also causes a duplicate value determination to be performed. An instruction format may include an opcode (e.g., a proper subset of the opcode) or field (e.g., operand or immediate) to indicate that the execution of a single, packed data sorting instruction causes only a single instance of duplicated values to be included in the sorted, packed data resultant. An instruction format may include an opcode (e.g., a proper subset of the opcode) or field (e.g., operand or immediate) to indicate that the execution of a single, packed data sorting instruction causes no instances of duplicated values to be included in the sorted, packed data resultant. An instruction format may include an opcode (e.g., a proper subset of the opcode) or field (e.g., operand or immediate) to indicate that the execution of a single, packed data sorting instruction causes a flag to set when duplicated values of the packed data source are determined. An instruction may include one or more (e.g., any) of the fields discussed herein.

The instructions disclosed herein are improvements to the functioning of a processor (e.g., of a computer) itself. Instruction decode circuitry (e.g., a decoder) not having such an instruction as a part of its instruction set would not decode as discussed herein. An execution circuit not having such an instruction as a part of its instruction set would not execute as discussed herein. For example, a single instruction that, when a processor decodes the single instruction into a decoded instruction and that decoded instruction is executed by the processor, provides storage for a comparison matrix to store a comparison value for each element of the packed data source against the other elements of the packed data source, performs (e.g., a same) comparison operation on each element of the packed data source against the other elements of the packed data source to populate the comparison matrix, adds each column of results in the comparison matrix to generate each element of a packed data count, moves each element of the packed data source according to the packed data count to generate a packed data result that is sorted by the sort type indicated by the opcode, and stores the packed data result into the packed data destination, is an improvement to the functioning of the processor (e.g., of a computer) itself.

FIG. 1 illustrates a hardware processor 100 coupled to a memory 110 according to embodiments of the disclosure. Depicted hardware processor 100 includes a hardware decoder 102 (e.g., decode unit or decode circuit) and a hardware execution circuit 104 (e.g., execution unit). Depicted hardware processor 100 includes register(s) 106. Registers may include one or more of registers to access (e.g., load and/or store) data in, e.g., additionally or alternatively to access (e.g., load or store) of data in memory 110. Note that the figures herein may not depict all data communication connections. One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain embodiments herein.

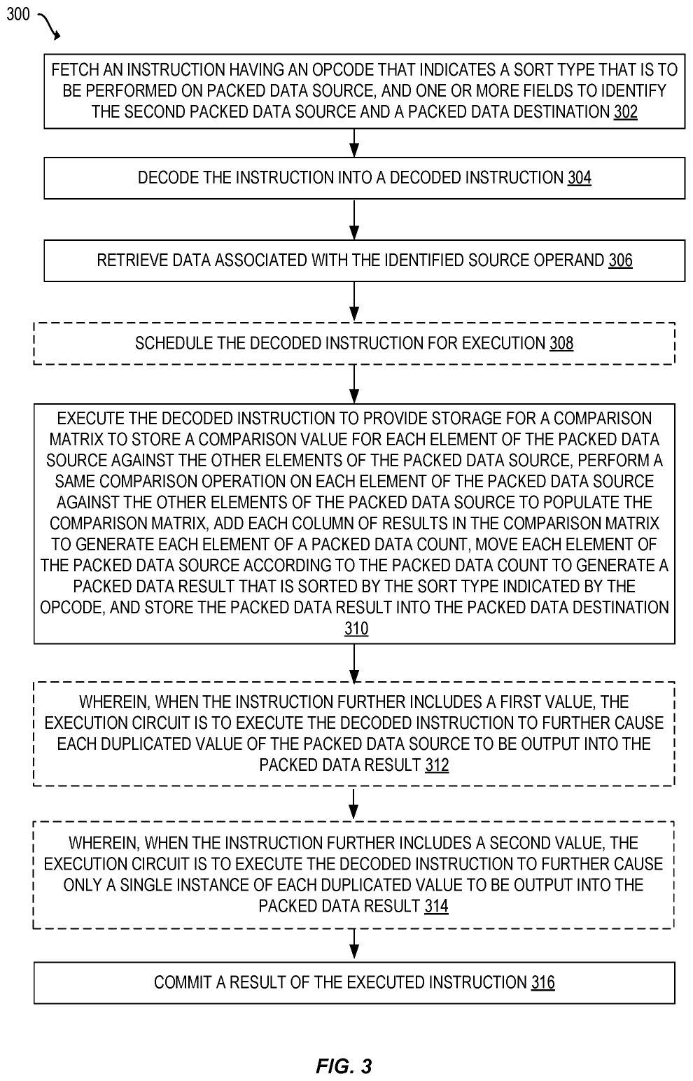

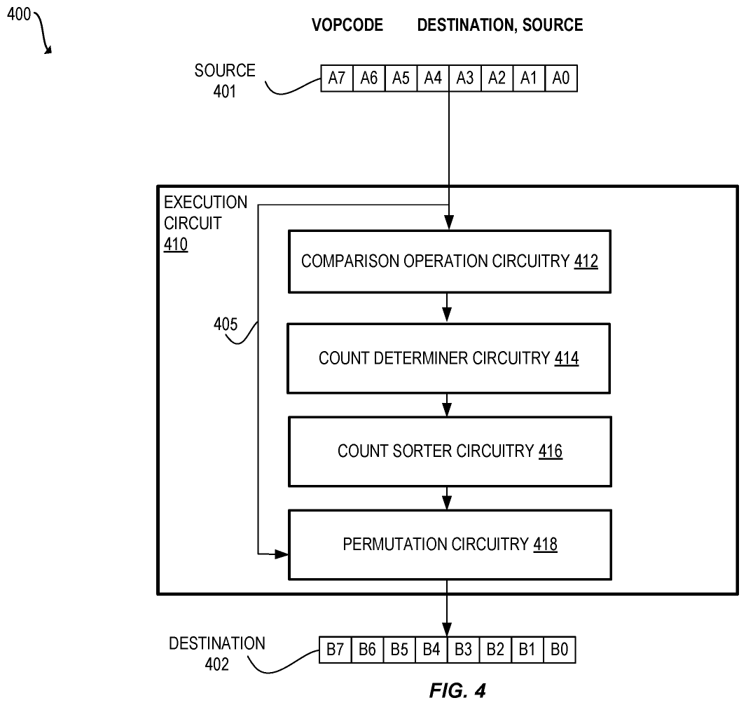

Hardware decoder 102 may receive an (e.g., single) instruction (e.g., macro-instruction) and decode the instruction, e.g., into micro-instructions and/or micro-operations. Hardware execution circuit 104 may execute the decoded instruction (e.g., macro-instruction) to perform an operation or operations. For example, an instruction to be decoded by decoder 102 and for the decoded instruction to be executed by execution circuit 104 may be any instruction discussed herein, e.g., in FIGS. 3-9. Hardware execution circuit 104 may be any of the execution circuits in FIGS. 4-9. Certain embodiments herein are directed to a processor that includes an instruction in its instruction set that performs a packed data sorting operation on a packed data source to generate a packed data resultant.

The decoder 102, execution circuit 104, and registers 106 may be of a single core of the processor, e.g., and multiple cores each with an instance of the circuitry may be included. The processor (e.g., and core thereof) may be a processor and/or core according to any of the disclosure herein.

FIG. 2 illustrates a hardware processor 200 coupled to storage 202 that includes one or more packed data sorting instructions 204 according to embodiments of the disclosure. In certain embodiments, a packed data sorting instruction is according to any of the disclosure herein. In one embodiment, e.g., in response to a request to perform an operation, the instruction (e.g., macro-instruction) is fetched from storage 202 and sent to decoder 206. In the depicted embodiment, the decoder 206 (e.g., decoder circuit) decodes the instruction into a decoded instruction (e.g., one or more micro-instructions or micro-operations). The decoded instruction is then sent for execution, e.g., via scheduler circuit 208 to schedule the decoded instruction for execution.

In certain embodiments, (e.g., where the processor/core supports out-of-order (OoO) execution), the processor includes a register rename/allocator circuit coupled to register file/memory circuit 210 (e.g., unit) to allocate resources (e.g., buffer 216) and perform register renaming on registers (e.g., vector registers associated with the initial source and final destination of the packed data sorting instruction). In certain embodiments, (e.g., for out-of-order execution), the processor includes one or more scheduler circuits 208 coupled to the decoder. The scheduler circuit(s) may schedule one or more operations associated with decoded instructions, including one or more operations decoded from a packed data sorting instruction, for execution on the execution circuit 212.

In certain embodiments, a write back circuit 214 is included to write back results (e.g., from buffer 216) of an instruction to a destination (e.g., write them to a register(s) and/or memory), for example, so those results are visible within a processor (e.g., visible outside of the execution circuit that produced those results).

One or more of these components (e.g., decoder 206, register rename/register allocator/scheduler 208, execution circuit 212, registers (e.g., register file)/memory 210, buffer 216, or write back circuit 214) may be in a single core of a hardware processor (e.g., and multiple cores each with an instance of these components.

FIG. 3 illustrates a method 300 of processing a packed data sorting instruction according to embodiments of the disclosure. A processor (e.g., or processor core) may perform method 300, e.g., in response to receiving a request to execute an instruction from software. Depicted method 300 includes processing a packed data sorting instruction by: fetch an instruction having an opcode that indicates a sort type that is to be performed on packed data source, and one or more fields to identify the second packed data source and a packed data destination 302, decode the instruction into a decoded instruction 304, retrieve data associated with the identified source operand 306, (optionally) schedule the decoded instruction for execution 308, execute the decoded instruction to provide storage for a comparison matrix to store a comparison value for each element of the packed data source against the other elements of the packed data source, perform a same comparison operation on each element of the packed data source against the other elements of the packed data source to populate the comparison matrix, add each column of results in the comparison matrix to generate each element of a packed data count, move each element of the packed data source according to the packed data count to generate a packed data result that is sorted by the sort type indicated by the opcode, and store the packed data result into the packed data destination 310, (optionally) wherein, when the instruction further includes a first value, the execution circuit is to execute the decoded instruction to further cause each duplicated value of the packed data source to be output into the packed data result 312, (optionally) wherein, when the instruction further includes a second value, the execution circuit is to execute the decoded instruction to further cause only a single instance of each duplicated value to be output into the packed data result 314, and commit a result of the executed instruction 316.

In certain embodiments, an instruction includes a format of having a vector opcode (vopcode) that indicates which sort type is to be performed. In certain embodiments, an instruction includes a format of having a vector opcode (vopcode) that indicates how the instruction is to respond to duplicates, e.g., to remove them from or keep them in the packed data destination (e.g., instruction resultant). In one embodiment, the vector opcode includes a value or letter (e.g., B) that indicates that the instruction operates on bytes of data (e.g., element sizes that are 1 or integer multiples of a byte).

In one embodiment, the width of each element in the input packed data is a single byte (8 bits). In the Figures herein, e.g., FIGS. 4-15, data may be loaded from a register/memory and or stored in a register or memory (e.g., only at the end of execution of the instruction). In certain embodiments, the packed data source (input) and the packed data destination (output) each have the same number of bits and/or elements. In certain embodiments, some or all of the data may be accessed in (e.g., system) memory. In certain embodiments, only the data storage circuitry within an execution circuit (e.g., unit) and a buffer is used to perform the operations of the execution of the instruction (e.g., the operations other than the loading of the packed data input values from a register/memory and the storing of the sorted packed data result of the final (e.g., not interim) value in register/memory). In one embodiment, a buffer is separate from the register and/or memory, e.g., where the time to access the buffer is less than the time to access the register and/or memory for a same width of data being accessed. The input and output vector values and sizes herein are also examples, and other values and sizes may be utilized. The data (e.g. the sorted data) may be according to big-endian or little-endian order.

FIG. 4 illustrates circuitry 400 including an execution circuit 410 with comparison operation circuitry 412, count determiner circuitry 414, count sorter circuitry 416, and permutation circuitry 418 according to embodiments of the disclosure. In certain embodiments, decoder (e.g., decoder 102 in FIG. 1 or decoder 206 in FIG. 2) decodes an instruction into a decoded instruction that causes execution circuit 410 to perform packed data sorting with comparison operation circuitry 412, count determiner circuitry 414, count sorter circuitry 416, and permutation circuitry 418 (for example, the decoded instruction indicate to execution circuit 410 which components to use, e.g., here to use comparison operation circuitry 412, count determiner circuitry 414, count sorter circuitry 416, and permutation circuitry 418). In the depicted embodiment, an instruction format may include one or more fields that identifies the packed data destination 402 and packed data source 401, and optionally, a second packed data source if all the packed data elements to be sorted do not fit within packed data source 401. In the depicted embodiment, the packed data source 401 includes eight elements (indexed 0-7). However, it should be understood that any number of elements, or a proper subset of any numbers, may be utilized with the instruction(s) disclosed herein. In certain embodiments, each element in a packed data source has a same bit width (e.g., a byte or bytes) as the other elements and/or the number of elements (e.g., and their bit width) are the same in the packed data source 401 and the packed data destination 402.

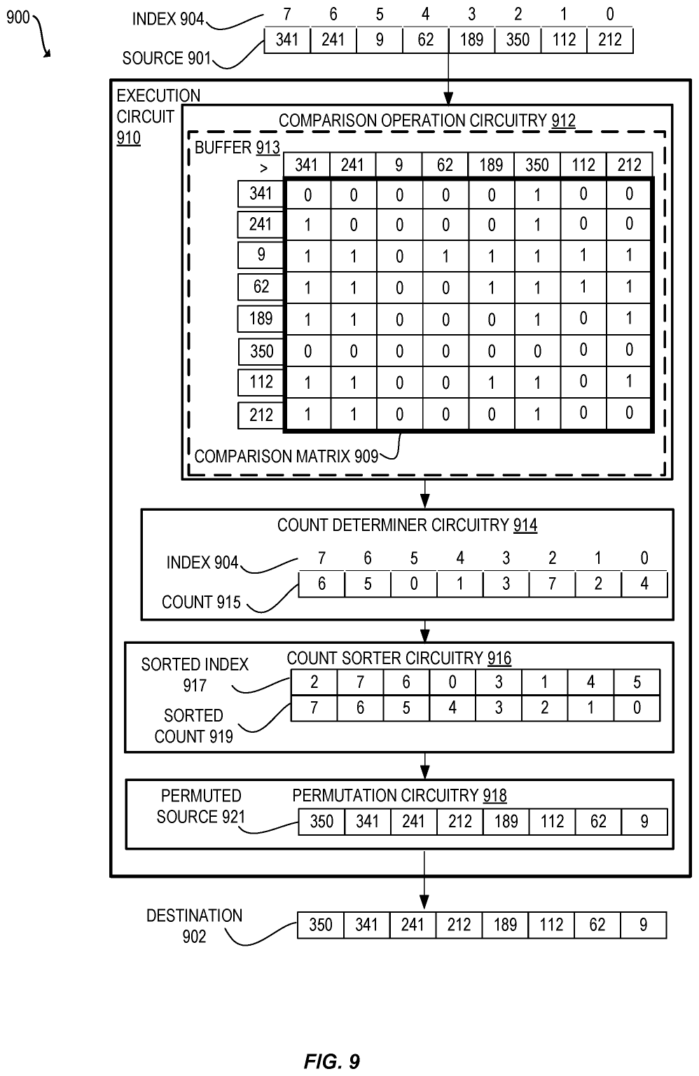

In certain embodiments, comparison operation circuitry 412 of execution circuit 410 performs an element by element comparison (e.g., including or not including the element being compared to the other elements) on the elements of the packed data source 401. In one embodiment, the type of comparison is a greater than, less then, greater than or equal to, or, less than or equal to operation, for example, with the same type of comparison performed on all of the elements against all of the (e.g., other) elements, to produce a plurality of comparison results (e.g., a comparison matrix as in FIG. 9).

In certain embodiments, the execution circuit 410 then causes count determiner circuitry 414 to determine a sum of the values for an element from its comparisons (e.g., to add the high bits in a column as shown in FIG. 9), and stores the sum of the values for each element in a corresponding element in a packed data count.

In certain embodiments, the execution circuit 410 then causes the packed data count from the count determiner circuitry 414 to be sent to the count sorter circuitry 416. In certain embodiments, the count sorter circuitry 416 sorts (e.g., by performing the type of sort indicated by the ocpode) the counts, e.g., while also sorting the index for each of the elements of the packed data source 401. In one embodiment, the vopcode indicates to the count sorter circuitry 416 the sort type (e.g., minimum to maximum sort or maximum to minimum sort) to be implemented.

In certain embodiments, the permutation circuitry 418 performs a permutation on the elements of the packed data source 401 (e.g., sourced via line 405) to generate a sorted, packed data result (e.g., vector) according to the output from the count sorter circuitry 416. In one embodiment, the permutation circuitry 918 uses a sorted index to store an element from the source 401 that has that index (e.g., the index for the data as it was stored in the source 401) into the (e.g., new) element position indicated by the sorted index.

The sorted, packed data result may then be stored into destination 402, e.g., with each of B7-B0 storing a respective single element.

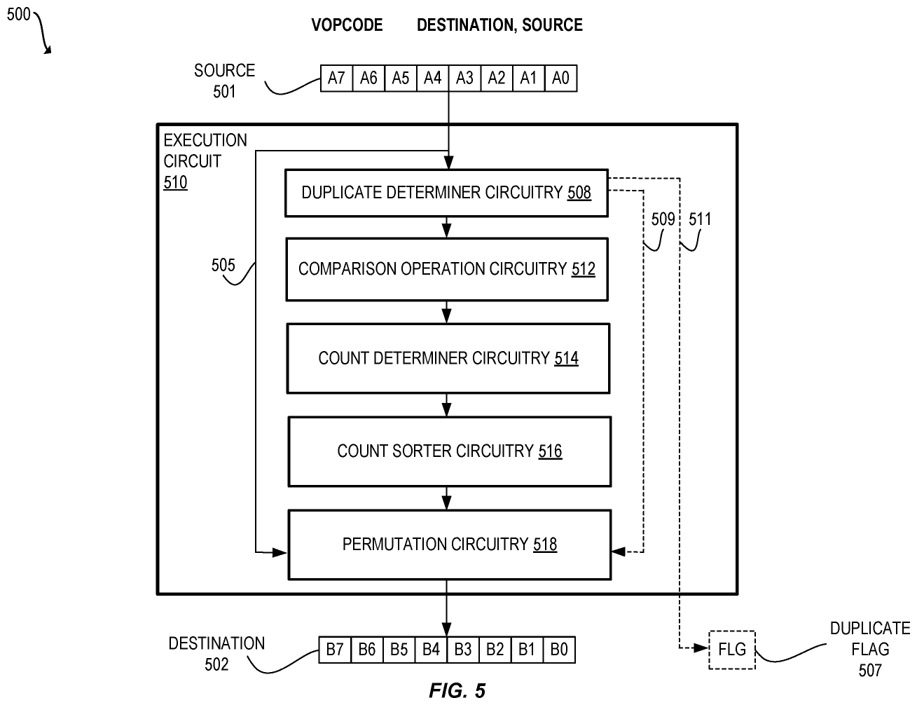

FIG. 5 illustrates circuitry 500 including an execution circuit 510 with duplicate determiner circuitry 508, comparison operation circuitry 512, count determiner circuitry 514, count sorter circuitry 516, and permutation circuitry 518 according to embodiments of the disclosure. In certain embodiments, decoder (e.g., decoder 102 in FIG. 1 or decoder 206 in FIG. 2) decodes an instruction into a decoded instruction that causes execution circuit 510 to perform packed data sorting with duplicate determiner circuitry 508, comparison operation circuitry 512, count determiner circuitry 514, count sorter circuitry 516, and permutation circuitry 518 (for example, the decoded instruction indicate to execution circuit 510 which components to use, e.g., here to use duplicate determiner circuitry 508, comparison operation circuitry 512, count determiner circuitry 514, count sorter circuitry 516, and permutation circuitry 518). In the depicted embodiment, an instruction format may include one or more fields that identifies the packed data destination 502 and packed data source 501, and optionally, a second packed data source if all the packed data elements to be sorted do not fit within packed data source 501. In the depicted embodiment, the packed data source 501 includes eight elements (indexed 0-7). However, it should be understood that any number of elements, or a proper subset of any numbers, may be utilized with the instruction(s) disclosed herein. In certain embodiments, each element in a packed data source has a same bit width (e.g., a byte or bytes) as the other elements and/or the number of elements (e.g., and their bit width) are the same in the packed data source 501 and the packed data destination 502.

In certain embodiments, an instruction (e.g., via vopcode or a field of the instruction), causes duplicate determiner circuitry 508 to determine if there are any duplicated values in packed data source 501. In certain embodiments (e.g., according to vopcode or a field of the instruction), duplicate determiner circuitry 508 causes the removal of (e.g., all but one of) the duplicated values of source 501. In one embodiment, duplicate determiner circuitry 508 removes (e.g., all but one of) the duplicated values of source 501 and provides the source 501 to comparison operation circuitry 512 without any duplicate values. In certain embodiments, duplicate determiner circuitry 508 does not remove (e.g., all but one of) the duplicated values of source 501 and provides the source 501 to comparison operation circuitry 512 with duplicate values. In one embodiment, duplicate determiner circuitry 508 sends an indicator value on line 509 to permutation circuitry 518 to, (i) when the indicator value is a first value, cause the permutation circuitry to remove (e.g., all but one of) the duplicated values of source 501 from the sorted packed data result output from the permutation circuitry 518 or (ii) when the indicator value is a second value, cause the permutation circuitry to not remove any of the duplicated values of source 501 from the sorted packed data result output from the permutation circuitry 518. In certain embodiments, duplicate determiner circuitry 508 asserts an optional duplicate flag on line 511 (e.g., to set a bit or bits in duplicate flag register 507) when it determines there are any duplicated values in packed data source 501, e.g., but the instruction execution also produces a sorted, packed data result into destination 502. In one embodiment, the duplicate flag functionality is turned on or off according to vopcode or a field of the instruction.

In certain embodiments, comparison operation circuitry 512 of execution circuit 510 performs an element by element comparison (e.g., including or not including the element being compared to the other elements) on the elements of the packed data source 501. In one embodiment, the type of comparison is a greater than, less then, greater than or equal to, or, less than or equal to operation, for example, with the same type of comparison performed on all of the elements against all of the (e.g., other) elements, to produce a plurality of comparison results (e.g., a comparison matrix as in FIG. 9).

In certain embodiments, the execution circuit 510 then causes count determiner circuitry 514 to determine a sum of the values for an element from its comparisons (e.g., to add the high bits in a column as shown in FIG. 9), and stores the sum of the values for each element in a corresponding element in a packed data count. In one embodiment, the vopcode indicates to the count sorter circuitry 516 the sort type (e.g., minimum to maximum sort or maximum to minimum sort).

In certain embodiments, the execution circuit 510 then causes the packed data count from the count determiner circuitry 514 to be sent to the count sorter circuitry 516. In certain embodiments, the count sorter circuitry 516 sorts (e.g., by performing the type of sort indicated by the ocpode) the counts, e.g., while also sorting the index for each of the elements of the packed data source 501.

In certain embodiments, the permutation circuitry 518 performs a permutation on the elements of the packed data source 501 (e.g., sourced via line 505) to generate a sorted, packed data result (e.g., vector) according to the output from the count sorter circuitry 516. In one embodiment, the permutation circuitry 918 uses a sorted index to store an element from the source 501 that has that index (e.g., the index for the data as it was stored in the source 501) into the (e.g., new) element position indicated by the sorted index.

The sorted, packed data result may then be stored into destination 502, e.g., with each of B7-B0 storing a respective single element.

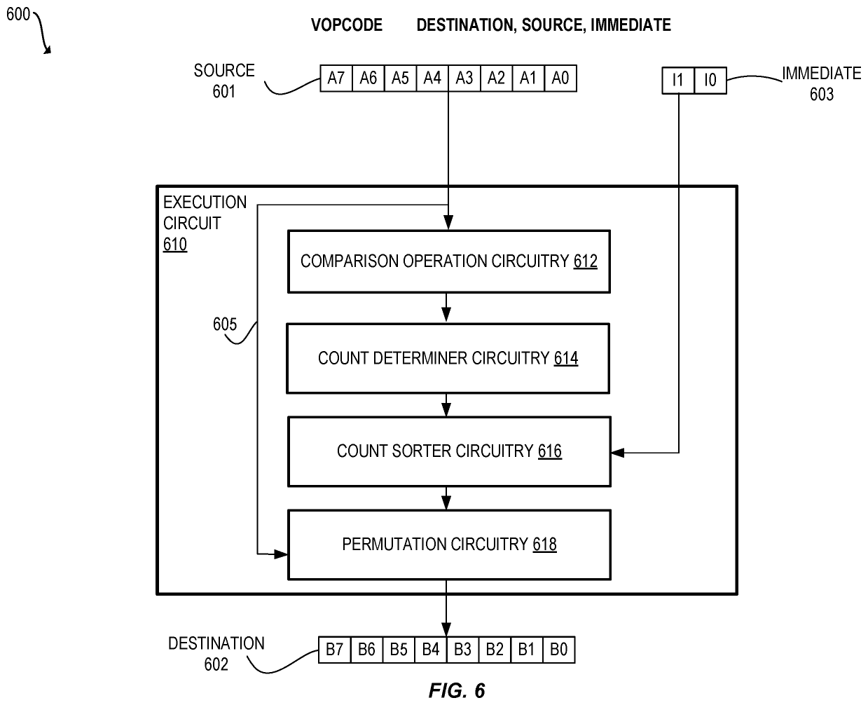

FIG. 6 illustrates circuitry 600 including an execution circuit 610 with comparison operation circuitry 612, count determiner circuitry 614, count sorter circuitry 616 that sources an immediate value 603, and permutation circuitry 618 according to embodiments of the disclosure.

In the depicted embodiment, the immediate 603 is an operand stored directly in the instruction. Although the depicted immediate shows two packed data elements I1, I0, it may be a single element or any other plurality of elements in other embodiments. For example, I1 may be set to a first value (e.g., 1) to indicate a first sort type and thus to cause count sorter circuitry 616 to perform a sort of the first type or a second value (e.g., 0) to indicate a second sort type and thus to cause count sorter circuitry 616 to perform a sort of the second (different) type.

In certain embodiments, decoder (e.g., decoder 102 in FIG. 1 or decoder 206 in FIG. 2) decodes an instruction into a decoded instruction that causes execution circuit 610 to perform packed data sorting with comparison operation circuitry 612, count determiner circuitry 614, count sorter circuitry 616, and permutation circuitry 618 (for example, the decoded instruction indicate to execution circuit 610 which components to use, e.g., here to use comparison operation circuitry 612, count determiner circuitry 614, count sorter circuitry 616, and permutation circuitry 618). In the depicted embodiment, an instruction format may include one or more fields that identifies the packed data destination 602 and packed data source 601, and optionally, a second packed data source if all the packed data elements to be sorted do not fit within packed data source 601. In the depicted embodiment, the packed data source 601 includes eight elements (indexed 0-7). However, it should be understood that any number of elements, or a proper subset of any numbers, may be utilized with the instruction(s) disclosed herein. In certain embodiments, each element in a packed data source has a same bit width (e.g., a byte or bytes) as the other elements and/or the number of elements (e.g., and their bit width) are the same in the packed data source 601 and the packed data destination 602.

In certain embodiments, comparison operation circuitry 612 of execution circuit 610 performs an element by element comparison (e.g., including or not including the element being compared to the other elements) on the elements of the packed data source 601. In one embodiment, the type of comparison is a greater than, less then, greater than or equal to, or, less than or equal to operation, for example, with the same type of comparison performed on all of the elements against all of the (e.g., other) elements, to produce a plurality of comparison results (e.g., a comparison matrix as in FIG. 9).

In certain embodiments, the execution circuit 610 then causes count determiner circuitry 614 to determine a sum of the values for an element from its comparisons (e.g., to add the high bits in a column as shown in FIG. 9), and stores the sum of the values for each element in a corresponding element in a packed data count.

In certain embodiments, the execution circuit 610 then causes the packed data count from the count determiner circuitry 614 to be sent to the count sorter circuitry 616. In certain embodiments, the count sorter circuitry 616 sorts (e.g., by performing the type of sort indicated by the immediate 603) the counts, e.g., while also sorting the index for each of the elements of the packed data source 601. In one embodiment, a value of a bit or bits in the immediate 603 indicates to the count sorter circuitry 616 the sort type (e.g., minimum to maximum sort or maximum to minimum sort) to be implemented.

In certain embodiments, the permutation circuitry 618 performs a permutation on the elements of the packed data source 601 (e.g., sourced via line 605) to generate a sorted, packed data result (e.g., vector) according to the output from the count sorter circuitry 616. In one embodiment, the permutation circuitry 918 uses a sorted index to store an element from the source 601 that has that index (e.g., the index for the data as it was stored in the source 601) into the (e.g., new) element position indicated by the sorted index.

The sorted, packed data result may then be stored into destination 602, e.g., with each of B7-B0 storing a respective single element.

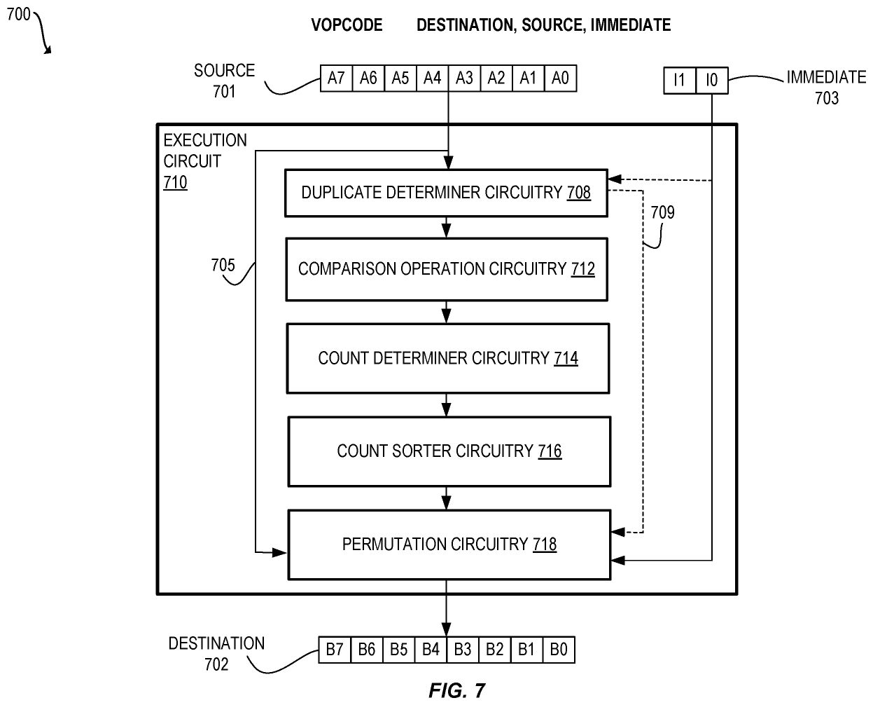

FIG. 7 illustrates circuitry 700 including an execution circuit 710 with duplicate determiner circuitry 708, comparison operation circuitry 712, count determiner circuitry 714, count sorter circuitry 716, and permutation circuitry 718 that sources an immediate value 703 according to embodiments of the disclosure. In the depicted embodiment, the immediate 703 is an operand stored directly in the instruction. Although the depicted immediate shows two packed data elements I1, I0, it may be a single element or any other plurality of elements in other embodiments. For example, I0 may be set to a first value (e.g., 1) to indicate a first mode for the permutation circuitry 718 (e.g., to cause removal of (e.g., all but one) of duplicated values from the sorted, packed data resultant) or a second value (e.g., 0) to indicate a second mode for the permutation circuitry 718 (e.g., to not cause removal of any duplicated values from the sorted, packed data resultant). Opcode or field of an instruction may indicate the sort type.

In certain embodiments, decoder (e.g., decoder 102 in FIG. 1 or decoder 206 in FIG. 2) decodes an instruction into a decoded instruction that causes execution circuit 710 to perform packed data sorting with duplicate determiner circuitry 708, comparison operation circuitry 712, count determiner circuitry 714, count sorter circuitry 716, and permutation circuitry 718 (for example, the decoded instruction indicate to execution circuit 710 which components to use, e.g., here to use duplicate determiner circuitry 708, comparison operation circuitry 712, count determiner circuitry 714, count sorter circuitry 716, and permutation circuitry 718). In the depicted embodiment, an instruction format may include one or more fields that identifies the packed data destination 702 and packed data source 701, and optionally, a second packed data source if all the packed data elements to be sorted do not fit within packed data source 701. In the depicted embodiment, the packed data source 701 includes eight elements (indexed 0-7). However, it should be understood that any number of elements, or a proper subset of any numbers, may be utilized with the instruction(s) disclosed herein. In certain embodiments, each element in a packed data source has a same bit width (e.g., a byte or bytes) as the other elements and/or the number of elements (e.g., and their bit width) are the same in the packed data source 701 and the packed data destination 702.

In certain embodiments, an instruction (for example, via vopcode or a field of the instruction, e.g., immediate 703), causes duplicate determiner circuitry 708 to determine if there are any duplicated values in packed data source 701. In certain embodiments (for example, via vopcode or a field of the instruction, e.g., immediate 703), duplicate determiner circuitry 708 causes the removal of (e.g., all but one of) he duplicated values of source 701. In one embodiment, duplicate determiner circuitry 708 removes (e.g., all but one of) the duplicated values of source 701 (for example, as indicated by vopcode or a field of the instruction, e.g., immediate 703) and provides the source 701 to comparison operation circuitry 712 without any duplicate values. In certain embodiments, duplicate determiner circuitry 708 does not remove (e.g., all but one of) the duplicated values of source 701 and provides the source 701 to comparison operation circuitry 712 with duplicate values. In one embodiment, duplicate determiner circuitry 708 sends an indicator value on line 709 to permutation circuitry 718 to indicate (e.g., each) value that is duplicated. In certain embodiments, a bit(s) of the immediate 703 being (i) set to a first value (e.g., 1) indicates a first mode to the permutation circuitry 718 to cause the permutation circuitry 718 to remove (e.g., all but one of) the duplicated values of source 701 from the sorted packed data result output from the permutation circuitry 718 or (ii) set to a second value (e.g., 0) indicates a second mode to the permutation circuitry 718 to cause the permutation circuitry to not remove any of the duplicated values of source 701 from the sorted packed data result output from the permutation circuitry 718. In certain embodiments, duplicate determiner circuitry 708 asserts an optional duplicate flag (e.g., to set a bit or bits in a duplicate flag register) when it determines there are any duplicated values in packed data source 701, e.g., but the instruction execution also produces a sorted, packed data result into destination 702. In one embodiment, the duplicate flag functionality is turned on or off according to vopcode or a field of the instruction.

In certain embodiments, comparison operation circuitry 712 of execution circuit 710 performs an element by element comparison (e.g., including or not including the element being compared to the other elements) on the elements of the packed data source 701. In one embodiment, the type of comparison is a greater than, less then, greater than or equal to, or, less than or equal to operation, for example, with the same type of comparison performed on all of the elements against all of the (e.g., other) elements, to produce a plurality of comparison results (e.g., a comparison matrix as in FIG. 9).

In certain embodiments, the execution circuit 710 then causes count determiner circuitry 714 to determine a sum of the values for an element from its comparisons (e.g., to add the high bits in a column as shown in FIG. 9), and stores the sum of the values for each element in a corresponding element in a packed data count. In one embodiment, the vopcode indicates to the count sorter circuitry 716 the sort type (e.g., minimum to maximum sort or maximum to minimum sort).

In certain embodiments, the execution circuit 710 then causes the packed data count from the count determiner circuitry 714 to be sent to the count sorter circuitry 716. In certain embodiments, the count sorter circuitry 716 sorts (e.g., by performing the type of sort indicated by the ocpode) the counts, e.g., while also sorting the index for each of the elements of the packed data source 701.

In certain embodiments, the permutation circuitry 718 performs a permutation on the elements of the packed data source 701 (e.g., sourced via line 705) to generate a sorted, packed data result (e.g., vector) according to the output from the count sorter circuitry 716. In one embodiment, the permutation circuitry 918 uses a sorted index to store an element from the source 701 that has that index (e.g., the index for the data as it was stored in the source 701) into the (e.g., new) element position indicated by the sorted index.

The sorted, packed data result may then be stored into destination 702, for example, with each of B7-B0 storing a respective single element (e.g., assuming no duplicated values are removed).

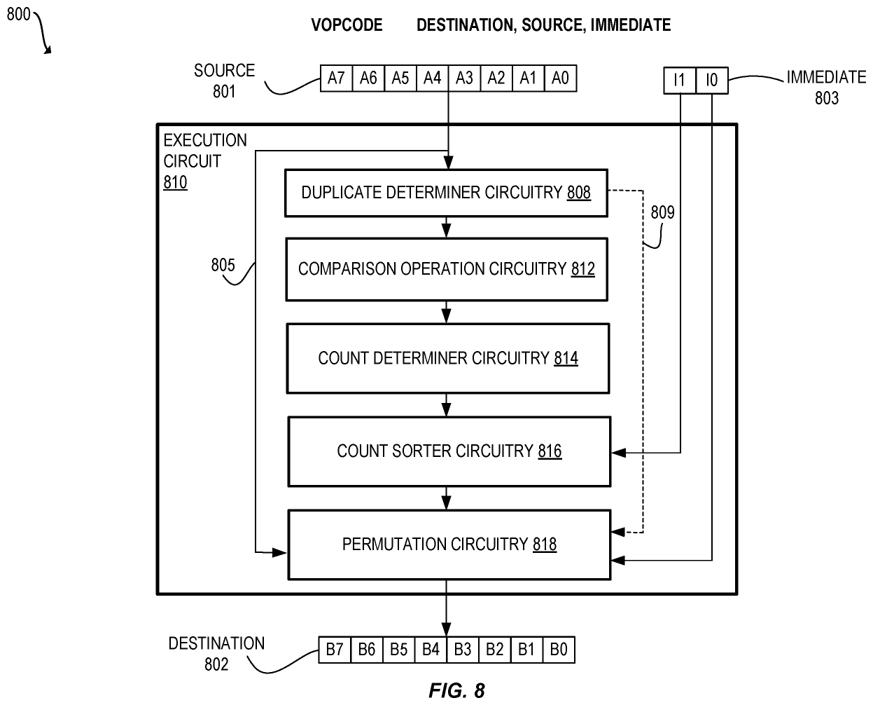

FIG. 8 illustrates circuitry 800 including an execution circuit 810 with duplicate determiner circuitry 808, comparison operation circuitry 812, count determiner circuitry 814, count sorter circuitry 816 that sources a first value from immediate 803, and permutation circuitry 818 that sources a second value from immediate 803 according to embodiments of the disclosure. In the depicted embodiment, the immediate 803 is an operand stored directly in the instruction. Although the depicted immediate shows two packed data elements I1, I0, it may be a single element or any other plurality of elements in other embodiments. For example, I0 may be set to a first value (e.g., 1) to indicate a first mode for the permutation circuitry 818 (e.g., to cause removal of (e.g., all but one) of duplicated values from the sorted, packed data resultant) or a second value (e.g., 0) to indicate a second mode for the permutation circuitry 818 (e.g., to not cause removal of any duplicated values from the sorted, packed data resultant). For example, I1 may be set to a first value (e.g., 1) to indicate a first sort type and thus to cause count sorter circuitry 816 to perform a sort of the first type or a second value (e.g., 0) to indicate a second sort type and thus to cause count sorter circuitry 816 to perform a sort of the second (different) type. Opcode or field of an instruction may indicate the sort type.

In certain embodiments, decoder (e.g., decoder 102 in FIG. 1 or decoder 206 in FIG. 2) decodes an instruction into a decoded instruction that causes execution circuit 810 to perform packed data sorting with duplicate determiner circuitry 808, comparison operation circuitry 812, count determiner circuitry 814, count sorter circuitry 816, and permutation circuitry 818 (for example, the decoded instruction indicate to execution circuit 810 which components to use, e.g., here to use duplicate determiner circuitry 808, comparison operation circuitry 812, count determiner circuitry 814, count sorter circuitry 816, and permutation circuitry 818). In the depicted embodiment, an instruction format may include one or more fields that identifies the packed data destination 802 and packed data source 801, and optionally, a second packed data source if all the packed data elements to be sorted do not fit within packed data source 801. In the depicted embodiment, the packed data source 801 includes eight elements (indexed 0-7). However, it should be understood that any number of elements, or a proper subset of any numbers, may be utilized with the instruction(s) disclosed herein. In certain embodiments, each element in a packed data source has a same bit width (e.g., a byte or bytes) as the other elements and/or the number of elements (e.g., and their bit width) are the same in the packed data source 801 and the packed data destination 802.

In certain embodiments, an instruction (for example, via vopcode or a field of the instruction, e.g., immediate 803), causes duplicate determiner circuitry 808 to determine if there are any duplicated values in packed data source 801. In certain embodiments (for example, via vopcode or a field of the instruction, e.g., immediate 803), duplicate determiner circuitry 808 causes the removal of (e.g., all but one of) he duplicated values of source 801. In one embodiment, duplicate determiner circuitry 808 removes (e.g., all but one of) the duplicated values of source 801 (for example, as indicated by vopcode or a field of the instruction, e.g., immediate 803) and provides the source 801 to comparison operation circuitry 812 without any duplicate values. In certain embodiments, duplicate determiner circuitry 808 does not remove (e.g., all but one of) the duplicated values of source 801 and provides the source 801 to comparison operation circuitry 812 with duplicate values. In one embodiment, duplicate determiner circuitry 808 sends an indicator value on line 809 to permutation circuitry 818 to indicate (e.g., each) value that is duplicated. In certain embodiments, a bit(s) of the immediate 803 being (i) set to a first value (e.g., 1) indicates a first mode to the permutation circuitry 818 to cause the permutation circuitry 818 to remove (e.g., all but one of) the duplicated values of source 801 from the sorted packed data result output from the permutation circuitry 818 or (ii) set to a second value (e.g., 0) indicates a second mode to the permutation circuitry 818 to cause the permutation circuitry to not remove any of the duplicated values of source 801 from the sorted packed data result output from the permutation circuitry 818. In certain embodiments, duplicate determiner circuitry 808 asserts an optional duplicate flag (e.g., to set a bit or bits in a duplicate flag register) when it determines there are any duplicated values in packed data source 801, e.g., but the instruction execution also produces a sorted, packed data result into destination 802. In one embodiment, the duplicate flag functionality is turned on or off according to vopcode or a field of the instruction.

In certain embodiments, comparison operation circuitry 812 of execution circuit 810 performs an element by element comparison (e.g., including or not including the element being compared to the other elements) on the elements of the packed data source 801. In one embodiment, the type of comparison is a greater than, less then, greater than or equal to, or, less than or equal to operation, for example, with the same type of comparison performed on all of the elements against all of the (e.g., other) elements, to produce a plurality of comparison results (e.g., a comparison matrix as in FIG. 9).

In certain embodiments, the execution circuit 810 then causes count determiner circuitry 814 to determine a sum of the values for an element from its comparisons (e.g., to add the high bits in a column as shown in FIG. 9), and stores the sum of the values for each element in a corresponding element in a packed data count.

In certain embodiments, the execution circuit 810 then causes the packed data count from the count determiner circuitry 814 to be sent to the count sorter circuitry 816. In certain embodiments, the count sorter circuitry 816 sorts (e.g., by performing the type of sort indicated by the immediate 803) the counts, e.g., while also sorting the index for each of the elements of the packed data source 801. In one embodiment, a value of a bit or bits in the immediate 803 indicates to the count sorter circuitry 816 the sort type (e.g., minimum to maximum sort or maximum to minimum sort) to be implemented.

In certain embodiments, the permutation circuitry 818 performs a permutation on the elements of the packed data source 801 (e.g., sourced via line 805) to generate a sorted, packed data result (e.g., vector) according to the output from the count sorter circuitry 816. In one embodiment, the permutation circuitry 918 uses a sorted index to store an element from the source 801 that has that index (e.g., the index for the data as it was stored in the source 801) into the (e.g., new) element position indicated by the sorted index.

The sorted, packed data result may then be stored into destination 802, for example, with each of B7-B0 storing a respective single element (e.g., assuming no duplicated values are removed).

FIG. 9 illustrates circuitry 900 including an execution circuit 910 with comparison operation circuitry 912, count determiner circuitry 914, count sorter circuitry 916, and permutation circuitry 918 according to embodiments of the disclosure. It should be understood that the values are merely examples, and this disclosure should not be so limited. In certain embodiments, decoder (e.g., decoder 102 in FIG. 1 or decoder 206 in FIG. 2) decodes an instruction into a decoded instruction that causes execution circuit 910 to perform packed data sorting with comparison operation circuitry 912, count determiner circuitry 914, count sorter circuitry 916, and permutation circuitry 918 (for example, the decoded instruction indicate to execution circuit 910 which components to use, e.g., here to use comparison operation circuitry 912, count determiner circuitry 914, count sorter circuitry 916, and permutation circuitry 918). In the depicted embodiment, an instruction format may include one or more fields that identifies the packed data destination 902 and packed data source 901, and optionally, a second packed data source if all the packed data elements to be sorted do not fit within packed data source 901. In the depicted embodiment, the packed data source 901 includes eight elements (indexed 0-7 in index 904). Index 904 may be implicit (e.g., based on each data element position of source 901), however, in other embodiments, a vector of index values may be explicit (e.g., stored within storage resources of execution circuit 910). It should be understood that any number of elements, or a proper subset of any numbers, may be utilized with the instruction(s) disclosed herein. In certain embodiments, each element in a packed data source has a same bit width (e.g., a byte or bytes) as the other elements and/or the number of elements (e.g., and their bit width) are the same in the packed data source 901 and the packed data destination 902.

In certain embodiments, comparison operation circuitry 912 of execution circuit 910 performs an element by element comparison (e.g., including the element being compared to the other elements) on the elements of the packed data source 901 to generate comparison matrix 909 in buffer 913 (e.g., an instance of buffer 216 in FIG. 2). In one embodiment, the type of comparison is a greater than, less then, greater than or equal to, or, less than or equal to operation (in the depicted embodiment, the comparison is a greater than and a bit is set high (1) when true and low (0) when false), for example, with the same type of comparison performed on all of the elements against all of the (e.g., other) elements, to produce a plurality of comparison results (e.g., comparison matrix 909).

In certain embodiments, the execution circuit 910 then causes count determiner circuitry 914 to determine a sum of the values for an element (e.g., with the index 904 in the same order as the source 901) from its comparisons (e.g., to add the high bits in a column as shown here), and stores the sum of the values for each element in a corresponding element in packed data count 915.

In certain embodiments, the execution circuit 910 then causes the packed data count 915 from the count determiner circuitry 914 to be sent to the count sorter circuitry 916. In certain embodiments, the count sorter circuitry 916 sorts (e.g., by performing the type of sort indicated by the ocpode) the counts, e.g., while also sorting the index for each of the elements of the packed data source 901 to generate a sorted index 917. In one embodiment, the vopcode indicates to the count sorter circuitry 916 the sort type (e.g., minimum to maximum sort or maximum to minimum sort) to be implemented.

In certain embodiments, the permutation circuitry 918 performs a permutation on the elements of the packed data source 901 (e.g., sourced from source 901) to generate a sorted, packed data result 921 (e.g., vector) according to the output from the count sorter circuitry 916. In one embodiment, the permutation circuitry 918 uses the sorted index 917 to store an element from the source 901 that has that index (e.g., the index for the data as it was stored in the source 901) into the (e.g., new) element position of the permuted source 921 as indicated by the sorted index. As one example, sorted count 919 has a 7 as its value in the left-most element that indicates that is the greatest value from source 901, and, the corresponding index for a count of 7 is the element position 2 of source 901, which is the data value of 350 as shown at the top of this page. Similarly, index 904 having a value of 7 corresponds to data value 341 in source 901, etc.

The sorted, packed data result 921 may then be stored into destination 902, e.g., with each of B7-B0 storing a respective single element.

In certain embodiments, performing the same comparison operation (e.g., rather than a different type of comparison above and below a diagonal of comparison matrix 909) for the entire comparison operation input source 901 saves energy and tracking resources that would have been associated with performing multiple types of comparison operations on source 901. However, in some of those embodiments, each duplicated value may produce the same comparison result (e.g., and thus the same sum of values in its element in the packed data count) and thus multiple elements of a packed data source will map to the same location (e.g., element position) in the packed data result. Thus, certain embodiments herein allow for the duplication (e.g., by permutation circuitry 918) of duplicated values that would not otherwise be included in the packed data result (destination), e.g., as all of the duplicate values would be mapped to a single, same element position in the packed data result.

In one embodiment, a processor includes a decoder to decode a single instruction into a decoded single instruction, the single instruction having at least one field that identifies a packed data source and a packed data destination, and an opcode that is to indicate a sort type; and an execution circuit to execute the decoded single instruction to: provide storage for a comparison matrix to store a comparison value for each element of the packed data source against the other elements of the packed data source, perform a same comparison operation on each element of the packed data source against the other elements of the packed data source to populate the comparison matrix, add each column of results in the comparison matrix to generate each element of a packed data count, move each element of the packed data source according to the packed data count to generate a packed data result that is sorted by the sort type indicated by the opcode, and store the packed data result into the packed data destination. The sort type may be a minimum to maximum sort. The sort type may be a maximum to minimum sort. The storage may not be a register. The packed data count may not be not stored in a register. The execution circuit may execute the decoded single instruction to further determine any duplicated values of the packed data source. The opcode of the single instruction may include a first value, and the execution circuit is to execute the decoded single instruction to further cause each of the duplicated values to be output into the packed data result. The opcode of the single instruction may include a second value, and the execution circuit may execute the decoded single instruction to further cause only a single instance of each of the duplicated values to be output into the packed data result. The execution circuit may execute the decoded single instruction to further set a flag in a register when the packed data source includes duplicated values.

In another embodiment, a method includes decoding a single instruction into a decoded single instruction with a decoder of a processor, the single instruction having at least one field that identifies a packed data source and a packed data destination, and an opcode that is to indicate a sort type; and executing the decoded single instruction with an execution circuit of the processor to: provide storage for a comparison matrix to store a comparison value for each element of the packed data source against the other elements of the packed data source, perform a same comparison operation on each element of the packed data source against the other elements of the packed data source to populate the comparison matrix, add each column of results in the comparison matrix to generate each element of a packed data count, move each element of the packed data source according to the packed data count to generate a packed data result that is sorted by the sort type indicated by the opcode, and store the packed data result into the packed data destination. The sort type may be a minimum to maximum sort. The sort type may be a maximum to minimum sort. The storage may not be a register. The packed data count may not be not stored in a register. The executing the decoded single instruction may further determine any duplicated values of the packed data source. The opcode of the single instruction may include a first value, and the executing the decoded single instruction may further cause each of the duplicated values to be output into the packed data result. The opcode of the single instruction may include a second value, and the executing the decoded single instruction may further cause only a single instance of each of the duplicated values to be output into the packed data result. The executing the decoded single instruction may further set a flag in a register when the packed data source includes duplicated values.

In yet another embodiment, a non-transitory machine readable medium that stores code that when executed by a machine causes the machine to perform a method including decoding a single instruction into a decoded single instruction with a decoder of a processor, the single instruction having at least one field that identifies a packed data source and a packed data destination, and an opcode that is to indicate a sort type; and executing the decoded single instruction with an execution circuit of the processor to: provide storage for a comparison matrix to store a comparison value for each element of the packed data source against the other elements of the packed data source, perform a same comparison operation on each element of the packed data source against the other elements of the packed data source to populate the comparison matrix, add each column of results in the comparison matrix to generate each element of a packed data count, move each element of the packed data source according to the packed data count to generate a packed data result that is sorted by the sort type indicated by the opcode, and store the packed data result into the packed data destination. The sort type may be a minimum to maximum sort. The sort type may be a maximum to minimum sort. The storage may not be a register. The packed data count may not be not stored in a register. The executing the decoded single instruction may further determine any duplicated values of the packed data source. The opcode of the single instruction may include a first value, and the executing the decoded single instruction may further cause each of the duplicated values to be output into the packed data result. The opcode of the single instruction may include a second value, and the executing the decoded single instruction may further cause only a single instance of each of the duplicated values to be output into the packed data result. The executing the decoded single instruction may further set a flag in a register when the packed data source includes duplicated values.

In another embodiment, a processor includes a first means to decode a single instruction into a decoded single instruction, the single instruction having at least one field that identifies a packed data source and a packed data destination, and an opcode that is to indicate a sort type; and a second means to execute the decoded single instruction to: provide storage for a comparison matrix to store a comparison value for each element of the packed data source against the other elements of the packed data source, perform a same comparison operation on each element of the packed data source against the other elements of the packed data source to populate the comparison matrix, add each column of results in the comparison matrix to generate each element of a packed data count, move each element of the packed data source according to the packed data count to generate a packed data result that is sorted by the sort type indicated by the opcode, and store the packed data result into the packed data destination.

In yet another embodiment, an apparatus comprises a data storage device that stores code that when executed by a hardware processor causes the hardware processor to perform any method disclosed herein. An apparatus may be as described in the detailed description. A method may be as described in the detailed description.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source 1/destination and source 2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, November 2018; and see Intel® Architecture Instruction Set Extensions Programming Reference, October 2018).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

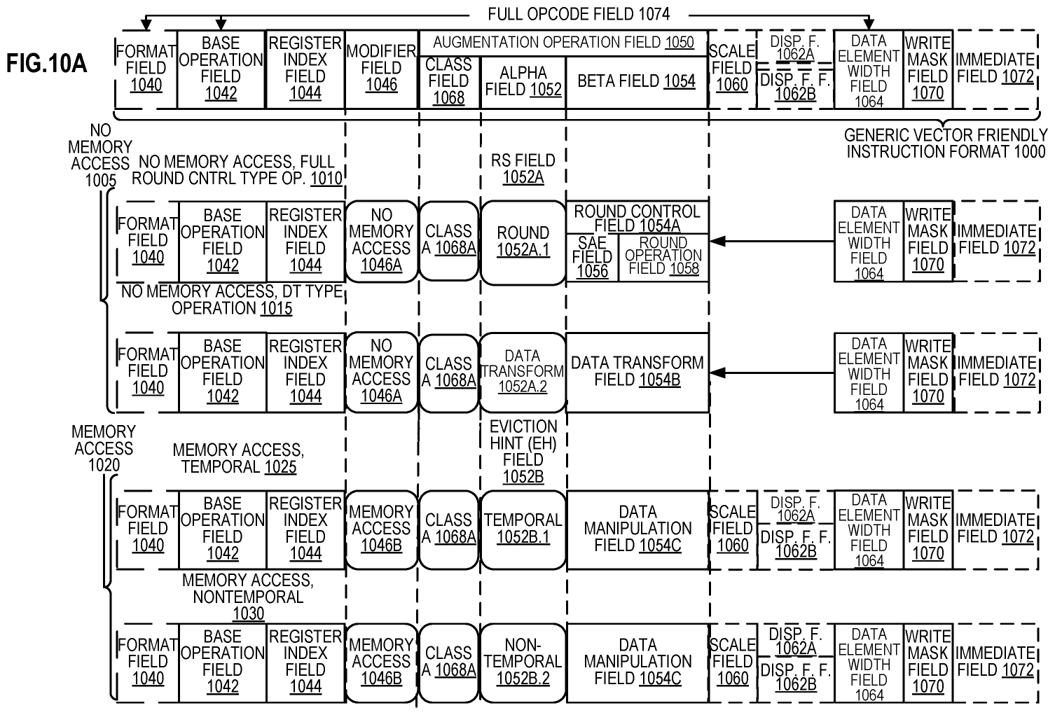

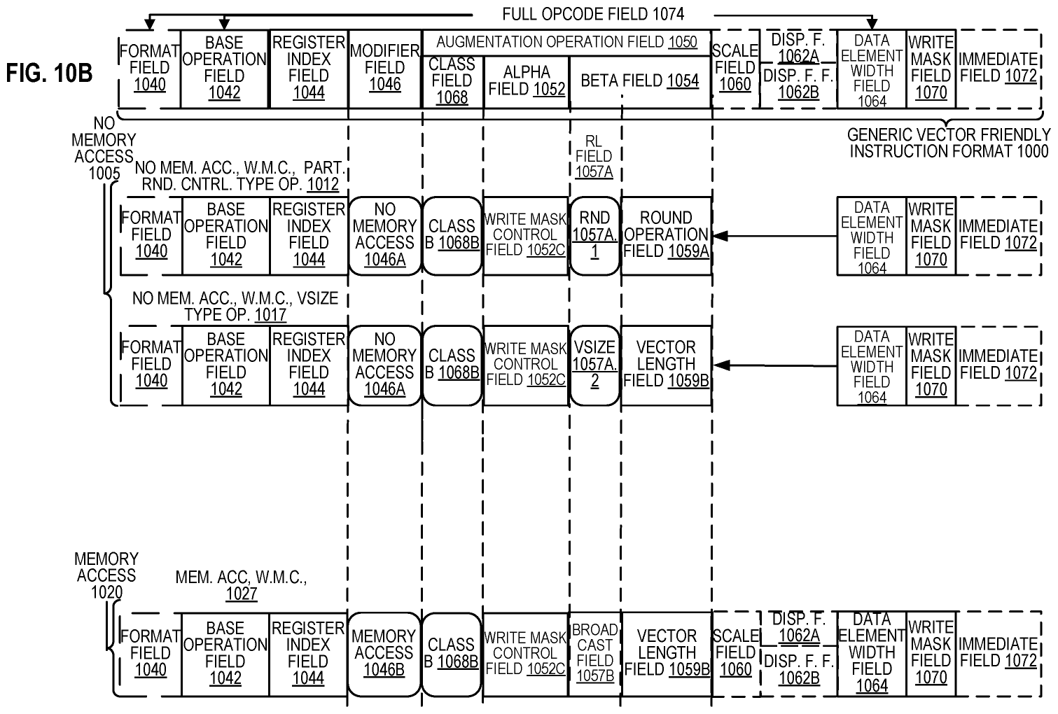

FIGS. 10A-10B are block diagrams illustrating a generic vector friendly instruction format and instruction templates thereof according to embodiments of the disclosure. FIG. 10A is a block diagram illustrating a generic vector friendly instruction format and class A instruction templates thereof according to embodiments of the disclosure; while FIG. 10B is a block diagram illustrating the generic vector friendly instruction format and class B instruction templates thereof according to embodiments of the disclosure. Specifically, a generic vector friendly instruction format 1000 for which are defined class A and class B instruction templates, both of which include no memory access 1005 instruction templates and memory access 1020 instruction templates. The term generic in the context of the vector friendly instruction format refers to the instruction format not being tied to any specific instruction set.

While embodiments of the disclosure will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 10A include: 1) within the no memory access 1005 instruction templates there is shown a no memory access, full round control type operation 1010 instruction template and a no memory access, data transform type operation 1015 instruction template; and 2) within the memory access 1020 instruction templates there is shown a memory access, temporal 1025 instruction template and a memory access, non-temporal 1030 instruction template. The class B instruction templates in FIG. 10B include: 1) within the no memory access 1005 instruction templates there is shown a no memory access, write mask control, partial round control type operation 1012 instruction template and a no memory access, write mask control, vsize type operation 1017 instruction template; and 2) within the memory access 1020 instruction templates there is shown a memory access, write mask control 1027 instruction template.

The generic vector friendly instruction format 1000 includes the following fields listed below in the order illustrated in FIGS. 10A-10B.

Format field 1040—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 1042—its content distinguishes different base operations.

Register index field 1044—its content, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 1046—its content distinguishes occurrences of instructions in the generic vector instruction format that specify memory access from those that do not; that is, between no memory access 1005 instruction templates and memory access 1020 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 1050—its content distinguishes which one of a variety of different operations to be performed in addition to the base operation. This field is context specific. In one embodiment of the disclosure, this field is divided into a class field 1068, an alpha field 1052, and a beta field 1054. The augmentation operation field 1050 allows common groups of operations to be performed in a single instruction rather than 2, 3, or 4 instructions.

Scale field 1060—its content allows for the scaling of the index field's content for memory address generation (e.g., for address generation that uses 2^{scale}*index+base).

Displacement Field 1062A—its content is used as part of memory address generation (e.g., for address generation that uses 2^{scale}*index+base+displacement).

Displacement Factor Field 1062B (note that the juxtaposition of displacement field 1062A directly over displacement factor field 1062B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1074 (described later herein) and the data manipulation field 1054C. The displacement field 1062A and the displacement factor field 1062B are optional in the sense that they are not used for the no memory access 1005 instruction templates and/or different embodiments may implement only one or none of the two.

Data element width field 1064—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 1070—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1070 allows for partial vector operations, including loads, stores, arithmetic, logical, etc. While embodiments of the disclosure are described in which the write mask field's 1070 content selects one of a number of write mask registers that contains the write mask to be used (and thus the write mask field's 1070 content indirectly identifies that masking to be performed), alternative embodiments instead or additional allow the mask write field's 1070 content to directly specify the masking to be performed.

Immediate field 1072—its content allows for the specification of an immediate. This field is optional in the sense that is it not present in an implementation of the generic vector friendly format that does not support immediate and it is not present in instructions that do not use an immediate.

Class field 1068—its content distinguishes between different classes of instructions. With reference to FIGS. 10A-B, the contents of this field select between class A and class B instructions. In FIGS. 10A-B, rounded corner squares are used to indicate a specific value is present in a field (e.g., class A 1068A and class B 1068B for the class field 1068 respectively in FIGS. 10A-B).

### Instruction Templates of Class A

In the case of the non-memory access 1005 instruction templates of class A, the alpha field 1052 is interpreted as an RS field 1052A, whose content distinguishes which one of the different augmentation operation types are to be performed (e.g., round 1052A. 1 and data transform 1052A.2 are respectively specified for the no memory access, round type operation 1010 and the no memory access, data transform type operation 1015 instruction templates), while the beta field 1054 distinguishes which of the operations of the specified type is to be performed. In the no memory access 1005 instruction templates, the scale field 1060, the displacement field 1062A, and the displacement scale filed 1062B are not present.

### No-Memory Access Instruction Templates—Full Round Control Type Operation

In the no memory access full round control type operation 1010 instruction template, the beta field 1054 is interpreted as a round control field 1054A, whose content(s) provide static rounding. While in the described embodiments of the disclosure the round control field 1054A includes a suppress all floating point exceptions (SAE) field 1056 and a round operation control field 1058, alternative embodiments may support may encode both these concepts into the same field or only have one or the other of these concepts/fields (e.g., may have only the round operation control field 1058).

SAE field 1056—its content distinguishes whether or not to disable the exception event reporting; when the SAE field's 1056 content indicates suppression is enabled, a given instruction does not report any kind of floating-point exception flag and does not raise any floating point exception handler.

Round operation control field 1058—its content distinguishes which one of a group of rounding operations to perform (e.g., Round-up, Round-down, Round-towards-zero and Round-to-nearest). Thus, the round operation control field 1058 allows for the changing of the rounding mode on a per instruction basis. In one embodiment of the disclosure where a processor includes a control register for specifying rounding modes, the round operation control field's 1050 content overrides that register value.

### No Memory Access Instruction Templates—Data Transform Type Operation

In the no memory access data transform type operation 1015 instruction template, the beta field 1054 is interpreted as a data transform field 1054B, whose content distinguishes which one of a number of data transforms is to be performed (e.g., no data transform, swizzle, broadcast).

In the case of a memory access 1020 instruction template of class A, the alpha field 1052 is interpreted as an eviction hint field 1052B, whose content distinguishes which one of the eviction hints is to be used (in FIG. 10A, temporal 1052B.1 and non-temporal 1052B.2 are respectively specified for the memory access, temporal 1025 instruction template and the memory access, non-temporal 1030 instruction template), while the beta field 1054 is interpreted as a data manipulation field 1054C, whose content distinguishes which one of a number of data manipulation operations (also known as primitives) is to be performed (e.g., no manipulation; broadcast; up conversion of a source; and down conversion of a destination). The memory access 1020 instruction templates include the scale field 1060, and optionally the displacement field 1062A or the displacement scale field 1062B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 1052 is interpreted as a write mask control (Z) field 1052C, whose content distinguishes whether the write masking controlled by the write mask field 1070 should be a merging or a zeroing.

In the case of the non-memory access 1005 instruction templates of class B, part of the beta field 1054 is interpreted as an RL field 1057A, whose content distinguishes which one of the different augmentation operation types are to be performed (e.g., round 1057A.1 and vector length (VSIZE) 1057A.2 are respectively specified for the no memory access, write mask control, partial round control type operation 1012 instruction template and the no memory access, write mask control, VSIZE type operation 1017 instruction template), while the rest of the beta field 1054 distinguishes which of the operations of the specified type is to be performed. In the no memory access 1005 instruction templates, the scale field 1060, the displacement field 1062A, and the displacement scale filed 1062B are not present.

In the no memory access, write mask control, partial round control type operation 1010 instruction template, the rest of the beta field 1054 is interpreted as a round operation field 1059A and exception event reporting is disabled (a given instruction does not report any kind of floating-point exception flag and does not raise any floating point exception handler).

Round operation control field 1059A—just as round operation control field 1058, its content distinguishes which one of a group of rounding operations to perform (e.g., Round-up, Round-down, Round-towards-zero and Round-to-nearest). Thus, the round operation control field 1059A allows for the changing of the rounding mode on a per instruction basis. In one embodiment of the disclosure where a processor includes a control register for specifying rounding modes, the round operation control field's 1050 content overrides that register value.

In the no memory access, write mask control, VSIZE type operation 1017 instruction template, the rest of the beta field 1054 is interpreted as a vector length field 1059B, whose content distinguishes which one of a number of data vector lengths is to be performed on (e.g., 128, 256, or 512 byte).

In the case of a memory access 1020 instruction template of class B, part of the beta field 1054 is interpreted as a broadcast field 1057B, whose content distinguishes whether or not the broadcast type data manipulation operation is to be performed, while the rest of the beta field 1054 is interpreted the vector length field 1059B. The memory access 1020 instruction templates include the scale field 1060, and optionally the displacement field 1062A or the displacement scale field 1062B.

With regard to the generic vector friendly instruction format 1000, a full opcode field 1074 is shown including the format field 1040, the base operation field 1042, and the data element width field 1064. While one embodiment is shown where the full opcode field 1074 includes all of these fields, the full opcode field 1074 includes less than all of these fields in embodiments that do not support all of them. The full opcode field 1074 provides the operation code (opcode).

The augmentation operation field 1050, the data element width field 1064, and the write mask field 1070 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the disclosure, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the disclosure). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the disclosure. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

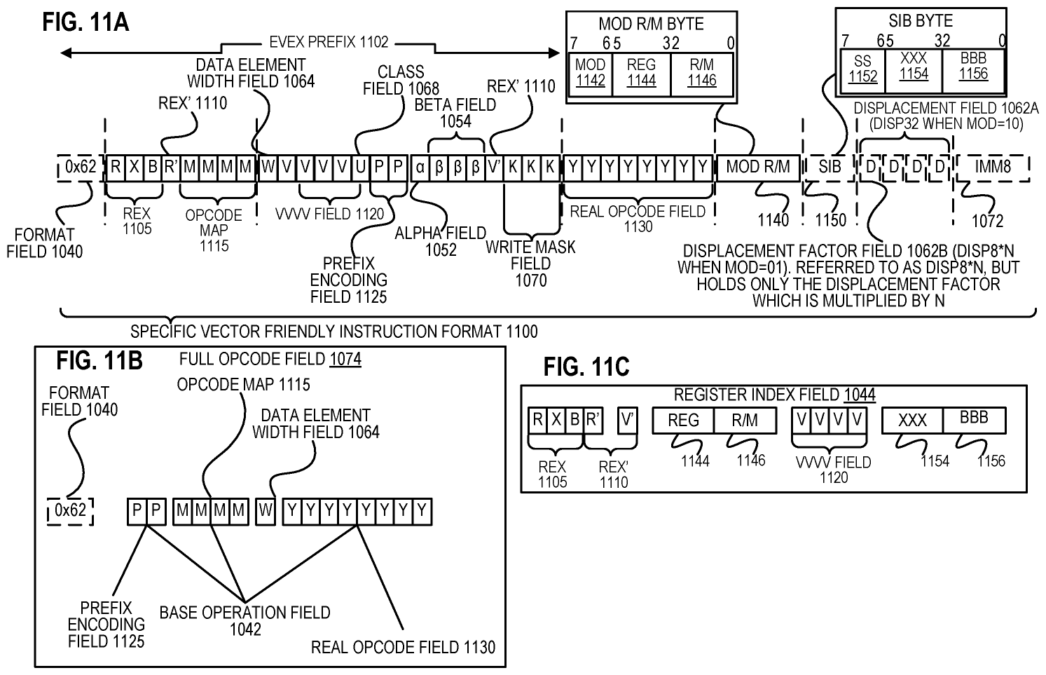

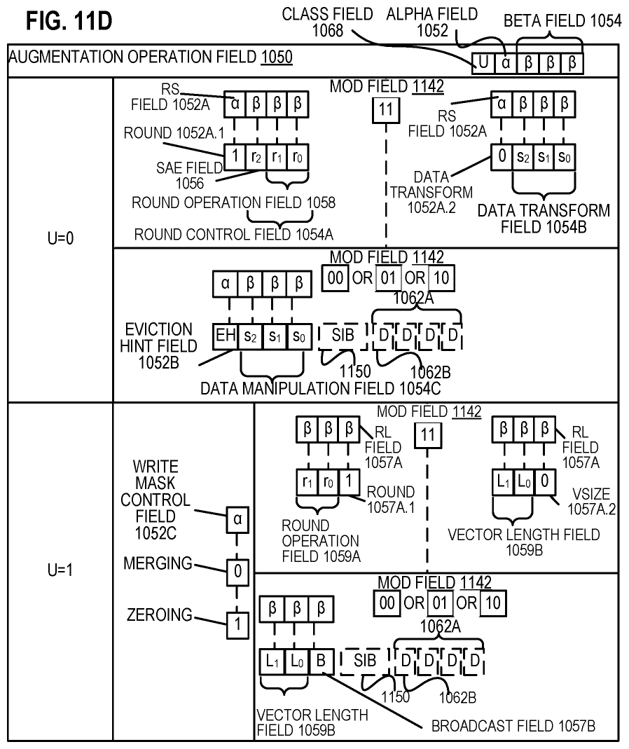

FIG. 11 is a block diagram illustrating an exemplary specific vector friendly instruction format according to embodiments of the disclosure. FIG. 11 shows a specific vector friendly instruction format 1100 that is specific in the sense that it specifies the location, size, interpretation, and order of the fields, as well as values for some of those fields. The specific vector friendly instruction format 1100 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 10 into which the fields from FIG. 11 map are illustrated.

It should be understood that, although embodiments of the disclosure are described with reference to the specific vector friendly instruction format 1100 in the context of the generic vector friendly instruction format 1000 for illustrative purposes, the disclosure is not limited to the specific vector friendly instruction format 1100 except where claimed. For example, the generic vector friendly instruction format 1000 contemplates a variety of possible sizes for the various fields, while the specific vector friendly instruction format 1100 is shown as having fields of specific sizes. By way of specific example, while the data element width field 1064 is illustrated as a one bit field in the specific vector friendly instruction format 1100, the disclosure is not so limited (that is, the generic vector friendly instruction format 1000 contemplates other sizes of the data element width field 1064).

The generic vector friendly instruction format 1000 includes the following fields listed below in the order illustrated in FIG. 11A.

EVEX Prefix (Bytes 0-3) 1102—is encoded in a four-byte form.

Format Field 1040 (EVEX Byte 0, bits [7:0])—the first byte (EVEX Byte 0) is the format field 1040 and it contains 0x62 (the unique value used for distinguishing the vector friendly instruction format in one embodiment of the disclosure).

The second-fourth bytes (EVEX Bytes 1-3) include a number of bit fields providing specific capability.

REX field 1105 (EVEX Byte 1, bits [7-5])—consists of a EVEX.R bit field (EVEX Byte 1, bit [7]—R), EVEX.X bit field (EVEX byte 1, bit [6]—X), and 1057BEX byte 1, bit[5]—B). The EVEX.R, EVEX.X, and EVEX.B bit fields provide the same functionality as the corresponding VEX bit fields, and are encoded using is complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1010—this is the first part of the REX′ field 1010 and is the EVEX.R′ bit field (EVEX Byte 1, bit [4]—R′) that is used to encode either the upper 16 or lower 16 of the extended 32 register set. In one embodiment of the disclosure, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the disclosure do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1115 (EVEX byte 1, bits [3:0]—mmmm)—its content encodes an implied leading opcode byte (0F, 0F 38, or 0F 3).

Data element width field 1064 (EVEX byte 2, bit [7]—W)—is represented by the notation EVEX.W. EVEX.W is used to define the granularity (size) of the datatype (either 32-bit data elements or 64-bit data elements).

EVEX.vvvv 1120 (EVEX Byte 2, bits [6:3]—vvvv)—the role of EVEX.vvvv may include the following: 1) EVEX.vvvv encodes the first source register operand, specified in inverted (is complement) form and is valid for instructions with 2 or more source operands; 2) EVEX.vvvv encodes the destination register operand, specified in 1 s complement form for certain vector shifts; or 3) EVEX.vvvv does not encode any operand, the field is reserved and should contain 111 lb. Thus, EVEX.vvvv field 1120 encodes the 4 low-order bits of the first source register specifier stored in inverted (is complement) form. Depending on the instruction, an extra different EVEX bit field is used to extend the specifier size to 32 registers.

EVEX.U 1068 Class field (EVEX byte 2, bit [2]—U)—If EVEX.U=0, it indicates class A or EVEX.U0; if EVEX.U=1, it indicates class B or EVEX.U1.

Prefix encoding field 1125 (EVEX byte 2, bits [1:0]—pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1052 (EVEX byte 3, bit [7]—EH; also known as EVEX.EH, EVEX.rs, EVEX.RL, EVEX.write mask control, and EVEX.N; also illustrated with α)—as previously described, this field is context specific.

Beta field 1054 (EVEX byte 3, bits [6:4]—SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 1010—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1070 (EVEX byte 3, bits [2:0]—kkk)—its content specifies the index of a register in the write mask registers as previously described. In one embodiment of the disclosure, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1130 (Byte 4) is also known as the opcode byte. Part of the opcode is specified in this field.

MOD R/M Field 1140 (Byte 5) includes MOD field 1142, Reg field 1144, and R/M field 1146. As previously described, the MOD field's 1142 content distinguishes between memory access and non-memory access operations. The role of Reg field 1144 can be summarized to two situations: encoding either the destination register operand or a source register operand, or be treated as an opcode extension and not used to encode any instruction operand. The role of R/M field 1146 may include the following: encoding the instruction operand that references a memory address, or encoding either the destination register operand or a source register operand.

Scale, Index, Base (SIB) Byte (Byte 6)—As previously described, the scale field's 1050 content is used for memory address generation. SIB.xxx 1154 and SIB.bbb 1156—the contents of these fields have been previously referred to with regard to the register indexes Xxxx and Bbbb.

Displacement field 1062A (Bytes 7-10)—when MOD field 1142 contains 10, bytes 7-10 are the displacement field 1062A, and it works the same as the legacy 32-bit displacement (disp32) and works at byte granularity.

Displacement factor field 1062B (Byte 7)—when MOD field 1142 contains 01, byte 7 is the displacement factor field 1062B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1062B is a reinterpretation of disp8; when using displacement factor field 1062B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1062B substitutes the legacy x86 instruction set 8-bit displacement. Thus, the displacement factor field 1062B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 1072 operates as previously described.

### Full Opcode Field

FIG. 11B is a block diagram illustrating the fields of the specific vector friendly instruction format 1100 that make up the full opcode field 1074 according to one embodiment of the disclosure. Specifically, the full opcode field 1074 includes the format field 1040, the base operation field 1042, and the data element width (W) field 1064. The base operation field 1042 includes the prefix encoding field 1125, the opcode map field 1115, and the real opcode field 1130.

### Register Index Field

FIG. 11C is a block diagram illustrating the fields of the specific vector friendly instruction format 1100 that make up the register index field 1044 according to one embodiment of the disclosure. Specifically, the register index field 1044 includes the REX field 1105, the REX′ field 1110, the MODR/M.reg field 1144, the MODR/M.r/m field 1146, the VVVV field 1120, xxx field 1154, and the bbb field 1156.

### Augmentation Operation Field

FIG. 11D is a block diagram illustrating the fields of the specific vector friendly instruction format 1100 that make up the augmentation operation field 1050 according to one embodiment of the disclosure. When the class (U) field 1068 contains 0, it signifies EVEX.U0 (class A 1068A); when it contains 1, it signifies EVEX.U1 (class B 1068B). When U=0 and the MOD field 1142 contains 11 (signifying a no memory access operation), the alpha field 1052 (EVEX byte 3, bit [7]—EH) is interpreted as the rs field 1052A. When the rs field 1052A contains a 1 (round 1052A.1), the beta field 1054 (EVEX byte 3, bits [6:4]—SSS) is interpreted as the round control field 1054A. The round control field 1054A includes a one bit SAE field 1056 and a two bit round operation field 1058. When the rs field 1052A contains a 0 (data transform 1052A.2), the beta field 1054 (EVEX byte 3, bits [6:4]—SSS) is interpreted as a three bit data transform field 1054B. When U=0 and the MOD field 1142 contains 00, 01, or 10 (signifying a memory access operation), the alpha field 1052 (EVEX byte 3, bit [7]—EH) is interpreted as the eviction hint (EH) field 1052B and the beta field 1054 (EVEX byte 3, bits [6:4]—SSS) is interpreted as a three bit data manipulation field 1054C.

When U=1, the alpha field 1052 (EVEX byte 3, bit [7]—EH) is interpreted as the write mask control (Z) field 1052C. When U=1 and the MOD field 1142 contains 11 (signifying a no memory access operation), part of the beta field 1054 (EVEX byte 3, bit [4]—S₀) is interpreted as the RL field 1057A; when it contains a 1 (round 1057A.1) the rest of the beta field 1054 (EVEX byte 3, bit [6-5]—S₂₋₁) is interpreted as the round operation field 1059A, while when the RL field 1057A contains a 0 (VSIZE 1057.A2) the rest of the beta field 1054 (EVEX byte 3, bit [6-5]—S₂₋₁) is interpreted as the vector length field 1059B (EVEX byte 3, bit [6-5]—L₁₋₀). When U=1 and the MOD field 1142 contains 00, 01, or 10 (signifying a memory access operation), the beta field 1054 (EVEX byte 3, bits [6:4]—SSS) is interpreted as the vector length field 1059B (EVEX byte 3, bit [6-5]—L₁₋₀) and the broadcast field 1057B (EVEX byte 3, bit [4]—B).

### Exemplary Register Architecture

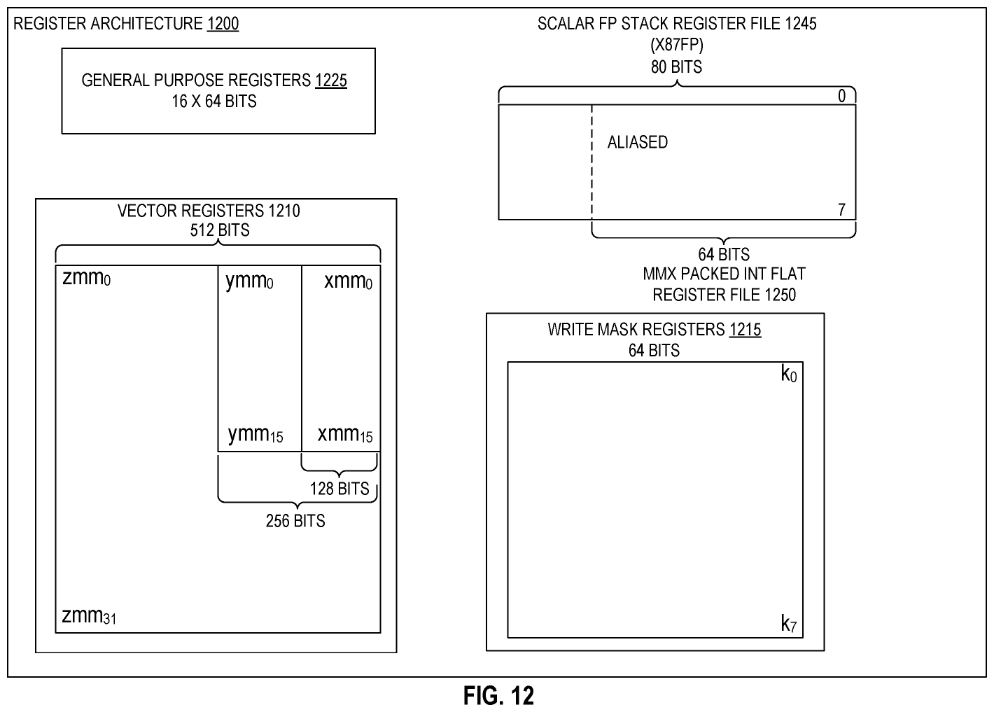

FIG. 12 is a block diagram of a register architecture 1200 according to one embodiment of the disclosure. In the embodiment illustrated, there are 32 vector registers 1210 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1100 operates on these overlaid register file as illustrated in the below tables.

| Adjustable Vector | | | |
|---|---|---|---|
| Length | Class | Operations | Registers |
| Instruction | A (FIG. 10A; | 1010, 1015, | zmm registers (the |
| Templates | U = 0) | 1025, 1030 | vector length is |
| that do not | | | 64 byte) |
| include the | B (FIG. 10B; | 1012 | zmm registers (the |
| vector length | U = 1) | | vector length is |
| field 1059B | | | 64 byte) |
| Instruction | B (FIG. 10B; | 1017, 1027 | zmm, ymm, or xmm |
| templates that | U = 1) | | registers (the |
| do include the | | | vector length is |
| vector length | | | 64 byte, 32 byte, or |
| field 1059B | | | 16 byte) depending |
| | | | on the vector |
| | | | length field 1059B |

In other words, the vector length field 1059B selects between a maximum length and one or more other shorter lengths, where each such shorter length is half the length of the preceding length; and instructions templates without the vector length field 1059B operate on the maximum vector length. Further, in one embodiment, the class B instruction templates of the specific vector friendly instruction format 1100 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1215—in the embodiment illustrated, there are 8 write mask registers (k0 through k7), each 64 bits in size. In an alternate embodiment, the write mask registers 1215 are 16 bits in size. As previously described, in one embodiment of the disclosure, the vector mask register k0 cannot be used as a write mask; when the encoding that would normally indicate k0 is used for a write mask, it selects a hardwired write mask of 0xFFFF, effectively disabling write masking for that instruction.

General-purpose registers 1225—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1245, on which is aliased the MMX packed integer flat register file 1250—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the disclosure may use wider or narrower registers. Additionally, alternative embodiments of the disclosure may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

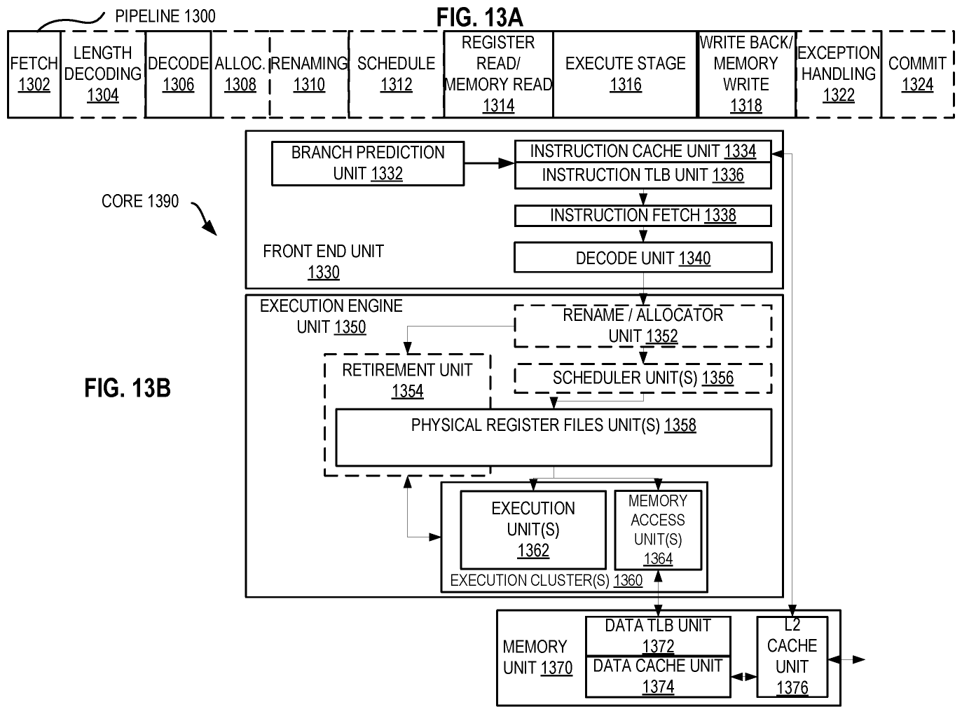

FIG. 13A is a block diagram illustrating both an exemplary in-order pipeline and an exemplary register renaming, out-of-order issue/execution pipeline according to embodiments of the disclosure. FIG. 13B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 13A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13A, a processor pipeline 1300 includes a fetch stage 1302, a length decode stage 1304, a decode stage 1306, an allocation stage 1308, a renaming stage 1310, a scheduling (also known as a dispatch or issue) stage 1312, a register read/memory read stage 1314, an execute stage 1316, a write back/memory write stage 1318, an exception handling stage 1322, and a commit stage 1324.

FIG. 13B shows processor core 1390 including a front end unit 1330 coupled to an execution engine unit 1350, and both are coupled to a memory unit 1370. The core 1390 may be a reduced instruction set computing (RISC) core, a complex instruction set computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front end unit 1330 includes a branch prediction unit 1332 coupled to an instruction cache unit 1334, which is coupled to an instruction translation lookaside buffer (TLB) 1336, which is coupled to an instruction fetch unit 1338, which is coupled to a decode unit 1340. The decode unit 1340 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 1340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1390 includes a microcode ROM or other medium that stores microcode for certain macro-instructions (e.g., in decode unit 1340 or otherwise within the front end unit 1330). The decode unit 1340 is coupled to a rename/allocator unit 1352 in the execution engine unit 1350.

The execution engine unit 1350 includes the rename/allocator unit 1352 coupled to a retirement unit 1354 and a set of one or more scheduler unit(s) 1356. The scheduler unit(s) 1356 represents any number of different schedulers, including reservations stations, central instruction window, etc. The scheduler unit(s) 1356 is coupled to the physical register file(s) unit(s) 1358. Each of the physical register file(s) units 1358 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1358 comprises a vector registers unit, a write mask registers unit, and a scalar registers unit. These register units may provide architectural vector registers, vector mask registers, and general purpose registers. The physical register file(s) unit(s) 1358 is overlapped by the retirement unit 1354 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1354 and the physical register file(s) unit(s) 1358 are coupled to the execution cluster(s) 1360. The execution cluster(s) 1360 includes a set of one or more execution units 1362 and a set of one or more memory access units 1364. The execution units 1362 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1356, physical register file(s) unit(s) 1358, and execution cluster(s) 1360 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1364). It should also be understood that where separate pipelines are used, one or more of these pipelines may be out-of-order issue/execution and the rest in-order.

The set of memory access units 1364 is coupled to the memory unit 1370, which includes a data TLB unit 1372 coupled to a data cache unit 1374 coupled to a level 2 (L2) cache unit 1376. In one exemplary embodiment, the memory access units 1364 may include a load unit, a store address unit, and a store data unit, each of which is coupled to the data TLB unit 1372 in the memory unit 1370. The instruction cache unit 1334 is further coupled to a level 2 (L2) cache unit 1376 in the memory unit 1370. The L2 cache unit 1376 is coupled to one or more other levels of cache and eventually to a main memory.

By way of example, the exemplary register renaming, out-of-order issue/execution core architecture may implement the pipeline 1300 as follows: 1) the instruction fetch 1338 performs the fetch and length decoding stages 1302 and 1304; 2) the decode unit 1340 performs the decode stage 1306; 3) the rename/allocator unit 1352 performs the allocation stage 1308 and renaming stage 1310; 4) the scheduler unit(s) 1356 performs the schedule stage 1312; 5) the physical register file(s) unit(s) 1358 and the memory unit 1370 perform the register read/memory read stage 1314; the execution cluster 1360 perform the execute stage 1316; 6) the memory unit 1370 and the physical register file(s) unit(s) 1358 perform the write back/memory write stage 1318; 7) various units may be involved in the exception handling stage 1322; and 8) the retirement unit 1354 and the physical register file(s) unit(s) 1358 perform the commit stage 1324.

The core 1390 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyper-Threading technology).

While register renaming is described in the context of out-of-order execution, it should be understood that register renaming may be used in an in-order architecture. While the illustrated embodiment of the processor also includes separate instruction and data cache units 1334/1374 and a shared L2 cache unit 1376, alternative embodiments may have a single internal cache for both instructions and data, such as, for example, a Level 1 (L) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

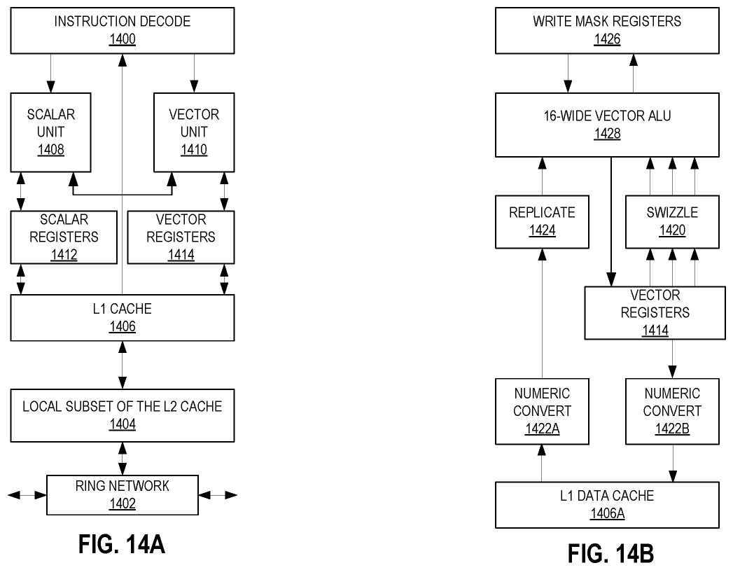

FIGS. 14A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 14A is a block diagram of a single processor core, along with its connection to the on-die interconnect network 1402 and with its local subset of the Level 2 (L2) cache 1404, according to embodiments of the disclosure. In one embodiment, an instruction decode unit 1400 supports the x86 instruction set with a packed data instruction set extension. An L1 cache 1406 allows low-latency accesses to cache memory into the scalar and vector units. While in one embodiment (to simplify the design), a scalar unit 1408 and a vector unit 1410 use separate register sets (respectively, scalar registers 1412 and vector registers 1414) and data transferred between them is written to memory and then read back in from a level 1 (L) cache 1406, alternative embodiments of the disclosure may use a different approach (e.g., use a single register set or include a communication path that allow data to be transferred between the two register files without being written and read back).

The local subset of the L2 cache 1404 is part of a global L2 cache that is divided into separate local subsets, one per processor core. Each processor core has a direct access path to its own local subset of the L2 cache 1404. Data read by a processor core is stored in its L2 cache subset 1404 and can be accessed quickly, in parallel with other processor cores accessing their own local L2 cache subsets. Data written by a processor core is stored in its own L2 cache subset 1404 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 14B is an expanded view of part of the processor core in FIG. 14A according to embodiments of the disclosure. FIG. 14B includes an L1 data cache 1406A part of the L1 cache 1404, as well as more detail regarding the vector unit 1410 and the vector registers 1414. Specifically, the vector unit 1410 is a 16-wide vector processing unit (VPU) (see the 16-wide ALU 1428), which executes one or more of integer, single-precision float, and double-precision float instructions. The VPU supports swizzling the register inputs with swizzle unit 1420, numeric conversion with numeric convert units 1422A-B, and replication with replication unit 1424 on the memory input. Write mask registers 1426 allow predicating resulting vector writes.

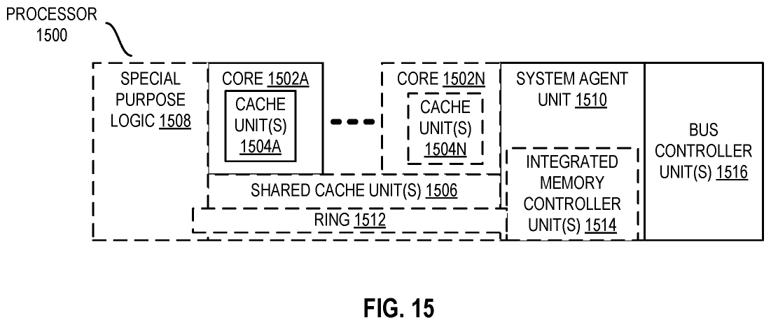

FIG. 15 is a block diagram of a processor 1500 that may have more than one core, may have an integrated memory controller, and may have integrated graphics according to embodiments of the disclosure. The solid lined boxes in FIG. 15 illustrate a processor 1500 with a single core 1502A, a system agent 1510, a set of one or more bus controller units 1516, while the optional addition of the dashed lined boxes illustrates an alternative processor 1500 with multiple cores 1502A-N, a set of one or more integrated memory controller unit(s) 1514 in the system agent unit 1510, and special purpose logic 1508.

Thus, different implementations of the processor 1500 may include: 1) a CPU with the special purpose logic 1508 being integrated graphics and/or scientific (throughput) logic (which may include one or more cores), and the cores 1502A-N being one or more general purpose cores (e.g., general purpose in-order cores, general purpose out-of-order cores, a combination of the two); 2) a coprocessor with the cores 1502A-N being a large number of special purpose cores intended primarily for graphics and/or scientific (throughput); and 3) a coprocessor with the cores 1502A-N being a large number of general purpose in-order cores. Thus, the processor 1500 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1500 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1506, and external memory (not shown) coupled to the set of integrated memory controller units 1514. The set of shared cache units 1506 may include one or more mid-level caches, such as level 2 (L2), level 3 (L3), level 4 (L4), or other levels of cache, a last level cache (LLC), and/or combinations thereof. While in one embodiment a ring based interconnect unit 1512 interconnects the integrated graphics logic 1508, the set of shared cache units 1506, and the system agent unit 1510/integrated memory controller unit(s) 1514, alternative embodiments may use any number of well-known techniques for interconnecting such units. In one embodiment, coherency is maintained between one or more cache units 1506 and cores 1502-A-N.

In some embodiments, one or more of the cores 1502A-N are capable of multithreading. The system agent 1510 includes those components coordinating and operating cores 1502A-N. The system agent unit 1510 may include for example a power control unit (PCU) and a display unit. The PCU may be or include logic and components needed for regulating the power state of the cores 1502A-N and the integrated graphics logic 1508. The display unit is for driving one or more externally connected displays.

The cores 1502A-N may be homogenous or heterogeneous in terms of architecture instruction set; that is, two or more of the cores 1502A-N may be capable of execution the same instruction set, while others may be capable of executing only a subset of that instruction set or a different instruction set.

### Exemplary Computer Architectures

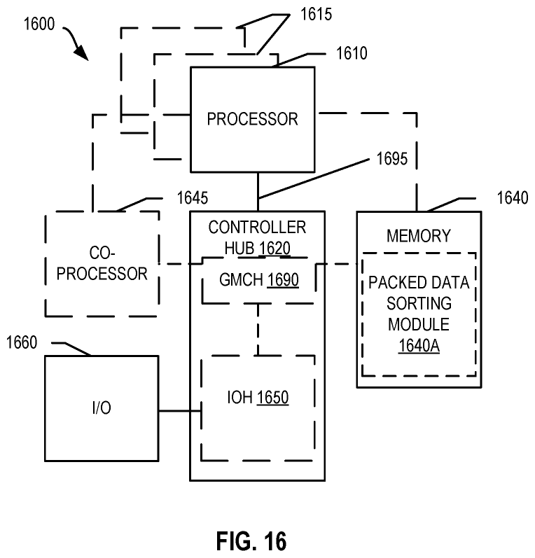

FIGS. 16-19 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 16, shown is a block diagram of a system 1600 in accordance with one embodiment of the present disclosure. The system 1600 may include one or more processors 1610, 1615, which are coupled to a controller hub 1620. In one embodiment the controller hub 1620 includes a graphics memory controller hub (GMCH) 1690 and an Input/Output Hub (IOH) 1650 (which may be on separate chips); the GMCH 1690 includes memory and graphics controllers to which are coupled memory 1640 and a coprocessor 1645; the IOH 1650 is couples input/output (I/O) devices 1660 to the GMCH 1690. Alternatively, one or both of the memory and graphics controllers are integrated within the processor (as described herein), the memory 1640 and the coprocessor 1645 are coupled directly to the processor 1610, and the controller hub 1620 in a single chip with the IOH 1650. Memory 1640 may include a vector packed data sorting module 1640A, for example, to store code that when executed causes a processor to perform any method of this disclosure.

The optional nature of additional processors 1615 is denoted in FIG. 16 with broken lines. Each processor 1610, 1615 may include one or more of the processing cores described herein and may be some version of the processor 1500.

The memory 1640 may be, for example, dynamic random access memory (DRAM), phase change memory (PCM), or a combination of the two. For at least one embodiment, the controller hub 1620 communicates with the processor(s) 1610, 1615 via a multi-drop bus, such as a frontside bus (FSB), point-to-point interface such as Quickpath Interconnect (QPI), or similar connection 1695.

In one embodiment, the coprocessor 1645 is a special-purpose processor, such as, for example, a high-throughput MIC processor, a network or communication processor, compression engine, graphics processor, GPGPU, embedded processor, or the like. In one embodiment, controller hub 1620 may include an integrated graphics accelerator.

There can be a variety of differences between the physical resources 1610, 1615 in terms of a spectrum of metrics of merit including architectural, microarchitectural, thermal, power consumption characteristics, and the like.

In one embodiment, the processor 1610 executes instructions that control data processing operations of a general type. Embedded within the instructions may be coprocessor instructions. The processor 1610 recognizes these coprocessor instructions as being of a type that should be executed by the attached coprocessor 1645. Accordingly, the processor 1610 issues these coprocessor instructions (or control signals representing coprocessor instructions) on a coprocessor bus or other interconnect, to coprocessor 1645. Coprocessor(s) 1645 accept and execute the received coprocessor instructions.

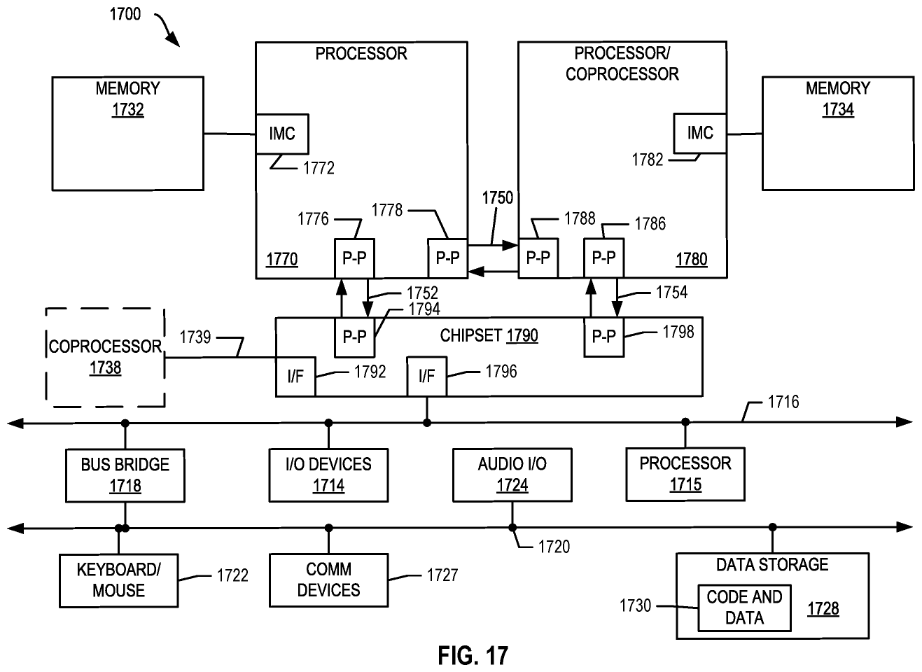

Referring now to FIG. 17, shown is a block diagram of a first more specific exemplary system 1700 in accordance with an embodiment of the present disclosure. As shown in FIG. 17, multiprocessor system 1700 is a point-to-point interconnect system, and includes a first processor 1770 and a second processor 1780 coupled via a point-to-point interconnect 1750. Each of processors 1770 and 1780 may be some version of the processor 1500. In one embodiment of the disclosure, processors 1770 and 1780 are respectively processors 1610 and 1615, while coprocessor 1738 is coprocessor 1645. In another embodiment, processors 1770 and 1780 are respectively processor 1610 coprocessor 1645.

Processors 1770 and 1780 are shown including integrated memory controller (IMC) units 1772 and 1782, respectively. Processor 1770 also includes as part of its bus controller units point-to-point (P-P) interfaces 1776 and 1778; similarly, second processor 1780 includes P-P interfaces 1786 and 1788. Processors 1770, 1780 may exchange information via a point-to-point (P-P) interface 1750 using P-P interface circuits 1778, 1788. As shown in FIG. 17, IMCs 1772 and 1782 couple the processors to respective memories, namely a memory 1732 and a memory 1734, which may be portions of main memory locally attached to the respective processors.

Processors 1770, 1780 may each exchange information with a chipset 1790 via individual P-P interfaces 1752, 1754 using point to point interface circuits 1776, 1794, 1786, 1798. Chipset 1790 may optionally exchange information with the coprocessor 1738 via a high-performance interface 1739. In one embodiment, the coprocessor 1738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1790 may be coupled to a first bus 1716 via an interface 1796. In one embodiment, first bus 1716 may be a Peripheral Component Interconnect (PCI) bus, or a bus such as a PCI Express bus or another third generation I/O interconnect bus, although the scope of the present disclosure is not so limited.

As shown in FIG. 17, various I/O devices 1714 may be coupled to first bus 1716, along with a bus bridge 1718 which couples first bus 1716 to a second bus 1720. In one embodiment, one or more additional processor(s) 1715, such as coprocessors, high-throughput MIC processors, GPGPU's, accelerators (such as, e.g., graphics accelerators or digital signal processing (DSP) units), field programmable gate arrays, or any other processor, are coupled to first bus 1716. In one embodiment, second bus 1720 may be a low pin count (LPC) bus. Various devices may be coupled to a second bus 1720 including, for example, a keyboard and/or mouse 1722, communication devices 1727 and a storage unit 1728 such as a disk drive or other mass storage device which may include instructions/code and data 1730, in one embodiment. Further, an audio I/O 1724 may be coupled to the second bus 1720. Note that other architectures are possible. For example, instead of the point-to-point architecture of FIG. 17, a system may implement a multi-drop bus or other such architecture.

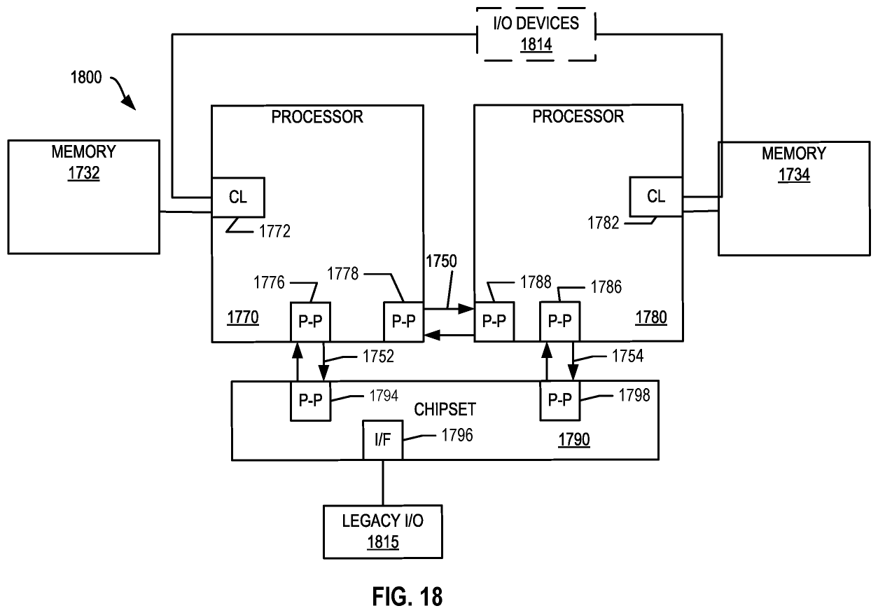

Referring now to FIG. 18, shown is a block diagram of a second more specific exemplary system 1800 in accordance with an embodiment of the present disclosure. Like elements in FIGS. 17 and 18 bear like reference numerals, and certain aspects of FIG. 17 have been omitted from FIG. 18 in order to avoid obscuring other aspects of FIG. 18.

FIG. 18 illustrates that the processors 1770, 1780 may include integrated memory and I/O control logic (“CL”) 1772 and 1782, respectively. Thus, the CL 1772, 1782 include integrated memory controller units and include I/O control logic. FIG. 18 illustrates that not only are the memories 1732, 1734 coupled to the CL 1772, 1782, but also that I/O devices 1814 are also coupled to the control logic 1772, 1782. Legacy I/O devices 1815 are coupled to the chipset 1790.

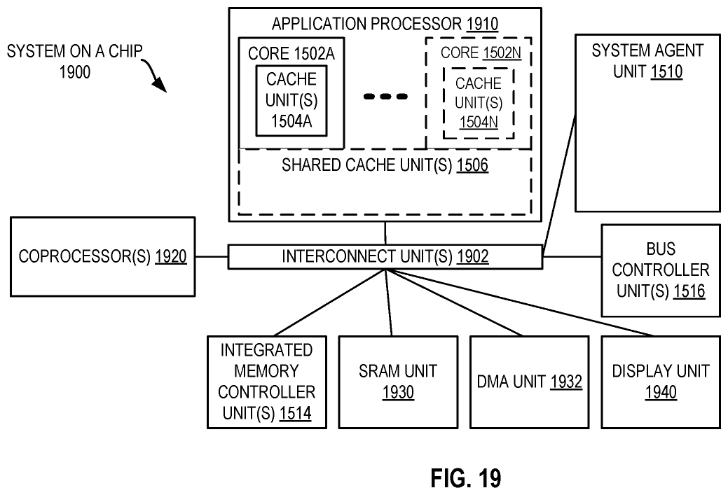

Referring now to FIG. 19, shown is a block diagram of a SoC 1900 in accordance with an embodiment of the present disclosure. Similar elements in FIG. 15 bear like reference numerals. Also, dashed lined boxes are optional features on more advanced SoCs. In FIG. 19, an interconnect unit(s) 1902 is coupled to: an application processor 1910 which includes a set of one or more cores 202A-N and shared cache unit(s) 1506; a system agent unit 1510; a bus controller unit(s) 1516; an integrated memory controller unit(s) 1514; a set or one or more coprocessors 1920 which may include integrated graphics logic, an image processor, an audio processor, and a video processor; an static random access memory (SRAM) unit 1930; a direct memory access (DMA) unit 1932; and a display unit 1940 for coupling to one or more external displays. In one embodiment, the coprocessor(s) 1920 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1730 illustrated in FIG. 17, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

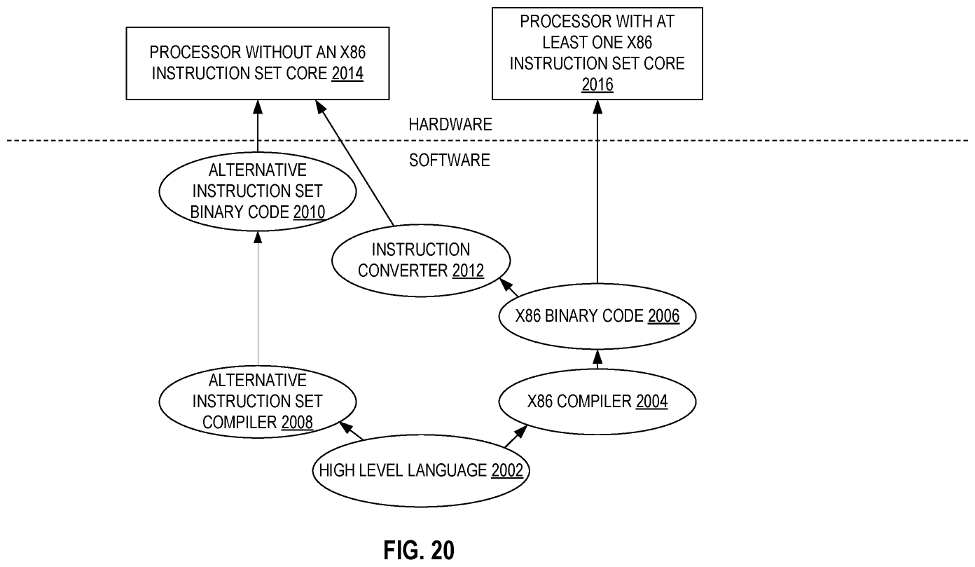

FIG. 20 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 20 shows a program in a high level language 2002 may be compiled using an x86 compiler 2004 to generate x86 binary code 2006 that may be natively executed by a processor with at least one x86 instruction set core 2016. The processor with at least one x86 instruction set core 2016 represents any processor that can perform substantially the same functions as an Intel® processor with at least one x86 instruction set core by compatibly executing or otherwise processing (1) a substantial portion of the instruction set of the Intel® x86 instruction set core or (2) object code versions of applications or other software targeted to run on an Intel® processor with at least one x86 instruction set core, in order to achieve substantially the same result as an Intel® processor with at least one x86 instruction set core. The x86 compiler 2004 represents a compiler that is operable to generate x86 binary code 2006 (e.g., object code) that can, with or without additional linkage processing, be executed on the processor with at least one x86 instruction set core 2016. Similarly, FIG. 20 shows the program in the high level language 2002 may be compiled using an alternative instruction set compiler 2008 to generate alternative instruction set binary code 2010 that may be natively executed by a processor without at least one x86 instruction set core 2014 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2012 is used to convert the x86 binary code 2006 into code that may be natively executed by the processor without an x86 instruction set core 2014. This converted code is not likely to be the same as the alternative instruction set binary code 2010 because an instruction converter capable of this is difficult to make; however, the converted code will accomplish the general operation and be made up of instructions from the alternative instruction set. Thus, the instruction converter 2012 represents software, firmware, hardware, or a combination thereof that, through emulation, simulation or any other process, allows a processor or other electronic device that does not have an x86 instruction set processor or core to execute the x86 binary code 2006.

What is claimed is:

1. A processor comprising:
a decoder to decode a single instruction into a decoded single instruction, the single instruction having at least one field that identifies a packed data source and a packed data destination, and an opcode that is to indicate a sort type; and
an execution circuit to execute the decoded single instruction to:
provide storage for a comparison matrix to store a comparison value for each element of the packed data source against the other elements of the packed data source,
perform a same comparison operation on each element of the packed data source against the other elements of the packed data source to populate the comparison matrix,
add each column of results in the comparison matrix to generate each element of a packed data count,
move each element of the packed data source according to the packed data count to generate a packed data result that is sorted by the sort type indicated by the opcode, and
store the packed data result into the packed data destination.

2. The processor of claim 1, wherein the sort type is a minimum to maximum sort.

3. The processor of claim 1, wherein the storage is not a register.

4. The processor of claim 1, wherein the packed data count is not stored in a register.

5. The processor of claim 1, wherein the execution circuit is to execute the decoded single instruction to further determine any duplicated values of the packed data source.

6. The processor of claim 5, wherein, when the opcode of the single instruction includes a first value, the execution circuit is to execute the decoded single instruction to further cause each of the duplicated values to be output into the packed data result.

7. The processor of claim 6, wherein, when the opcode of the single instruction includes a second value, the execution circuit is to execute the decoded single instruction to further cause only a single instance of each of the duplicated values to be output into the packed data result.

8. The processor of claim 5, wherein the execution circuit is to execute the decoded single instruction to further set a flag in a register when the packed data source includes duplicated values.

9. A method comprising:
decoding a single instruction into a decoded single instruction with a decoder of a processor, the single instruction having at least one field that identifies a packed data source and a packed data destination, and an opcode that is to indicate a sort type; and
executing the decoded single instruction with an execution circuit of the processor to:
provide storage for a comparison matrix to store a comparison value for each element of the packed data source against the other elements of the packed data source,
perform a same comparison operation on each element of the packed data source against the other elements of the packed data source to populate the comparison matrix,
add each column of results in the comparison matrix to generate each element of a packed data count,
move each element of the packed data source according to the packed data count to generate a packed data result that is sorted by the sort type indicated by the opcode, and
store the packed data result into the packed data destination.

10. The method of claim 9, wherein the sort type is a minimum to maximum sort.

11. The method of claim 9, wherein the storage is not a register.

12. The method of claim 9, wherein the packed data count is not stored in a register.

13. The method of claim 9, wherein the executing the decoded single instruction is to further determine any duplicated values of the packed data source.

14. The method of claim 13, wherein, when the opcode of the single instruction includes a first value, the executing the decoded single instruction is to further cause each of the duplicated values to be output into the packed data result.

15. The method of claim 14, wherein, when the opcode of the single instruction includes a second value, the executing the decoded single instruction is to further cause only a single instance of each of the duplicated values to be output into the packed data result.

16. The method of claim 13, wherein the executing the decoded single instruction is to further set a flag in a register when the packed data source includes duplicated values.

17. A non-transitory machine readable medium that stores code that when executed by a machine causes the machine to perform a method comprising:
decoding a single instruction into a decoded single instruction with a decoder of a processor, the single instruction having at least one field that identifies a packed data source and a packed data destination, and an opcode that is to indicate a sort type; and
executing the decoded single instruction with an execution circuit of the processor to:
provide storage for a comparison matrix to store a comparison value for each element of the packed data source against the other elements of the packed data source,
perform a same comparison operation on each element of the packed data source against the other elements of the packed data source to populate the comparison matrix,
add each column of results in the comparison matrix to generate each element of a packed data count,
move each element of the packed data source according to the packed data count to generate a packed data result that is sorted by the sort type indicated by the opcode, and
store the packed data result into the packed data destination.

18. The non-transitory machine readable medium of claim 17, wherein the sort type is a minimum to maximum sort.

19. The non-transitory machine readable medium of claim 17, wherein the storage is not a register.

20. The non-transitory machine readable medium of claim 17, wherein the packed data count is not stored in a register.

21. The non-transitory machine readable medium of claim 17, wherein the executing the decoded single instruction is to further determine any duplicated values of the packed data source.

22. The non-transitory machine readable medium of claim 21, wherein, when the opcode of the single instruction includes a first value, the executing the decoded single instruction is to further cause each of the duplicated values to be output into the packed data result.

23. The non-transitory machine readable medium of claim 22, wherein, when the opcode of the single instruction includes a second value, the executing the decoded single instruction is to further cause only a single instance of each of the duplicated values to be output into the packed data result.

24. The non-transitory machine readable medium of claim 21, wherein the executing the decoded single instruction is to further set a flag in a register when the packed data source includes duplicated values.
